(19) United States
(12) Patent Application Publication
(10) Pub. No.: US 2003/0158898 A1
(43) Pub. Date: Aug. 21, 2003

(54) Information processing apparatus, its control method, and program

(75) Inventors: Makoto Hirota, Tokyo (JP); Tetsuo Kosaka, Yonezawa-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA

(21) Appl. No.: 10/350,223

(22) Filed: Jan. 24, 2003

(30) Foreign Application Priority Data
Jan. 28, 2002 (JP) 018937/2002(PAT.)
Jan. 28, 2002 (JP) 018938/2002(PAT.)

(51) Int. Cl. G06F 15/16

(52) U.S. Cl. 709/204

(57) ABSTRACT

Modality information associated with modalities of a control device is received via a communication module. Also, dialog information associated with dialog of a device to be controlled is received via the communication module. A bind layer inference module generates bind information that infers the relationship between the modality information and dialog information, and binds the modality information and dialog information. The bind information and dialog information are transmitted to the control device via the communication module.

### FIELD OF THE INVENTION

The present invention relates to an information processing apparatus which supports control between a control device and a device to be controlled via a network, an information processing apparatus which serves as a control device that controls the operations of a device to be controlled, an information processing apparatus which serves as a device to be controlled that executes processes on the basis of instructions from a control device, their control method, and a program.

The present invention also relates to an information processing apparatus which has a plurality of types of modalities, and controls these modalities on the basis of a markup language or an information processing apparatus which serves as a control device for a device to be controlled on the basis of a markup language, its control method, and a program.

### BACKGROUND OF THE INVENTION

Web browsing that browses contents describes in a markup language called HTML using a browser is a globally spread technique at present. HTML is a markup language used to display contents. HTML has a mechanism called “form”, and can comprise GUI parts such as buttons, text boxes, and the like. With such language and a CGI (Common Gateway Interface), a Java Servlet or the like mechanism of a Web server, not only the contents are browsed, but also information can be sent, to the Web server, from a client (which means a computer and software that exploit functions and data provided by the server in the network; a computer connected to the network, a home personal computer, a Web browser, viewer, or the like, which runs on the computer, and so forth, correspond to the client), the Web server can execute an arbitrary program on the basis of this information, and the server can send back the result in an HTML format to the client. For example, a Web search engine is normally implemented by this method.

This mechanism can be applied not only to Web browsing but also to device control. More specifically, a device to be controlled mounts a Web server, and sends an HTML file that contains a form consisting of GUI parts used to control itself to a control device as a client in response to a request from that control device. The control device displays this HTML file on a browser, and the user operates a GUI on the control device. The control device sends user's input to the device to be controlled (e.g., Web server). In the device to be controlled, a CGI or a Java Servlet mechanism passes this input to a control program to attain control corresponding to the input.

On the other hand, in recent years, information device forms have diversified like portable terminals such as a PDA, mobile phone, car navigation system, and the like, and such devices other than a personal computer (to be referred to as a PC hereinafter) can establish connection to the Internet. Accordingly, a markup language such as WML or the like, that replaces HTML, has been developed and standardized. Also, along with the development of the speech recognition/synthesis technique and that of the CTI technique, access to Web can be made by a speech input via a phone, and a markup language such as VoiceXML or the like has been developed and standardized accordingly. In this manner, markup languages that match the device forms have been developed and standardized.

In addition to diversification of the device forms, UI modalities have also diversified (e.g., a GUI for a PC and PDA, speech and DTMF for a phone, and so forth) . A multi-modal user interface that improves the operability by efficiently combining such diversified modalities has received a lot of attention. A description of the multi-modal user interface requires at least a dialog description (that indicates correspondence between user's inputs and outputs, and a sequence of such inputs and outputs), and a modality description (that indicates UI parts to attain such inputs/outputs).

The modality description largely depends on the client form. Versatile devices such as a PC and the like have many GUIs, and some recent devices comprise a speech UI due to development of the speech recognition/synthesis technique. On the other hand, a mobile phone most suitably uses speech. This is because the mobile phone supports simple GUI parts on a small liquid crystal screen, but such GUI parts are not easy to use since no pointing device is available. In consideration of device control, a remote controller is used as a control device. It is a common practice to operate the remote controller using physical buttons.

The method of such dialog and modality descriptions includes two different methods.

In one method, the dialog description clearly specifies a description of modality input/output form (e.g., a given input uses a GUI button, and a given output uses speech). In the other method, the dialog and modality descriptions are separated, and the dialog description is given in a modality-independent form.

In the latter method, the dialog description as an operation sequence of a given device to be controlled is given in a modality-independent form, and modality descriptions are given in correspondence with various clients independently of the dialog description, thus allowing various clients to operate one device to be controlled. As a markup language for a multi-modal user interface that can independently form interactive and modality descriptions, CML (Japanese Patent Laid-Open No. 2001-154852) is known.

CML gives the dialog description itself in a modality-independent form, and has no scheme for giving the modality description and its control description. A dialog description part is converted into an existing markup language such as HTML, WML, VoiceXML, or the like to generate a modality description. Or upon directly executing CML by a browser, CML specifies those modalities of a device on which the browser runs, that are known by the browser, and correspondence between the modalities and input/output elements in the dialog description is determined by the browser.

Japanese Patent Laid-Open No. 2001-217850 has proposed a method of categorizing input/output elements of the dialog description as logical UIs, and the modalities of the modality description as representational UIs, and dynamically binding the representational UIs to the logical UIs of the device to be controlled.

In a future No-PC era, it is expected that every kinds of devices have CPUs and communication functions and link up with each other via a network to improve the user's convenience. In view of a UI, it is not overly unrealistic to predict implementation of a device operation environment independent of the types and locations of devices, in which home electric appliances and automatic vending machines are operated using, as remote controllers, mobile devices such as a mobile phone, digital camera, and the like. It is effective for implementation of such device operation environment to use the Web mechanism based on the markup languages. Furthermore, it is effective for implementation of the device operation environment independent of the types and locations of devices to use a markup language that allows a modality-independent description.

As described above, HTML, WML, VoiceXML, and the like as the existing markup languages are modality-dependent languages that assume certain control device forms. For this reason, a device to be controlled must prepare for a plurality of kinds of markup languages in correspondence with the assumed control devices so as to allow control from various kinds of devices. Also, HTML, WML, VoiceXML, and the like are not suitable for implementing a multi-modal user interface since they do not assume operations as combinations of a plurality of modalities.

CML is a modality-independent markup language, but is not suitable for implementing a multi-modal user interface since it uses the method of converting into the existing markup language such as HTML, WML, VoiceXML, or the like. On the other hand, upon directly executing CML by a browser, CML specifies those modalities of a device on which the browser runs, that are known by the browser, and correspondence between the modalities and input/output elements in the dialog description is determined by the browser. Hence, the correspondence between the modalities and input/output elements is fixed, thus jeopardizing flexibility that allows control depending on a description in a markup language.

Furthermore, Japanese Patent Laid-Open No. 2001-217850 binds logical and representational UIs very simply (for example, a logical UI that selects from some choices is bound to a representational UI such as a radio button, pull-down menu, or the like). In this case, since it is impossible to bind physical buttons to respective choices or to allow to select an item by repetitively pressing a single button, representational UIs that can be bound to logical UIs are limited to some extent.

### SUMMARY OF THE INVENTION

The present invention has been made to solve the aforementioned problems, and has as its object to provide an information processing apparatus, its control method, and a program, which easily make various devices function as a control device and a device to be controlled.

According to the present invention, the foregoing object is attained by providing an information processing apparatus which supports control between a control device and a device to be controlled via a network, comprising:

first reception means for receiving modality information associated with modalities of the control device;

second reception means for receiving dialog information associated with dialog of the device to be controlled;

generation means for generating bind information that infers a relationship between the modality information and the dialog information, and binds the modality information and the dialog information; and

transmission means for transmitting the bind information and the dialog information to the control device.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a diagram of an information processing system according to the first embodiment of the present invention;

FIG. 2 is a functional block diagram of a copier (copying machine) according to the first embodiment of the present invention;

FIG. 3 is a block diagram showing the hardware arrangement of the copier according to the first embodiment of the present invention;

FIG. 4 is a functional block diagram of a mobile phone according to the first embodiment of the present invention;

FIG. 5 is a block diagram showing the hardware arrangement of the mobile phone according to the first embodiment of the present invention;

FIG. 6 is a functional block diagram of a bind layer inference server according to the first embodiment of the present invention;

FIG. 7 is a block diagram showing the hardware arrangement of the bind layer inference server according to the first embodiment of the present invention;

FIG. 8 shows the structure of a markup language according to the first embodiment of the present invention;

FIG. 9 schematically expresses the schema description of generic modalities according to the first embodiment of the present invention;

FIG. 10 shows an example of the arrangement of a UI of the mobile phone according to the first embodiment of the present invention;

FIG. 11 schematically expresses the schema description of modalities of the mobile phone according to the first embodiment of the present invention;

FIG. 12 schematically expresses a dialog layer of the copier according to the first embodiment of the present invention;

FIG. 13 schematically expresses the description of a bind layer according to the first embodiment of the present invention;

FIG. 14 schematically expresses bind samples held by a bind layer inference unit according to the first embodiment of the present invention;

FIG. 15 shows an example of information to be transmitted from the mobile phone to the copier according to the first embodiment of the present invention;

FIG. 16 shows another example of information to be transmitted from the mobile phone to the copier according to the first embodiment of the present invention;

FIG. 17 schematically expresses a dialog layer of an air-conditioner according to the first embodiment of the present invention;

FIG. 18 is a flow chart showing the process to be executed by the bind layer inference server according to the first embodiment of the present invention;

FIG. 19A shows an example of XML expression of a generic modality schema according to the first embodiment of the present invention;

FIG. 19B shows an example of XML expression of a generic modality schema according to the first embodiment of the present invention;

FIG. 19C shows an example of XML expression of a generic modality schema according to the first embodiment of the present invention;

FIG. 19D shows an example of XML expression of a generic modality schema according to the first embodiment of the present invention;

FIG. 19E shows an example of XML expression of a generic modality schema according to the first embodiment of the present invention;

FIG. 20A shows an example of XML expression of a modality schema of the mobile phone according to the first embodiment of the present invention;

FIG. 20B shows an example of XML expression of a modality schema of the mobile phone according to the first embodiment of the present invention;

FIG. 21A shows an example of XML expression of the dialog layer of the copier according to the first embodiment of the present invention;

FIG. 21B shows an example of XML expression of the dialog layer of the copier according to the first embodiment of the present invention;

FIG. 22 shows an example of XML expression of a bind layer which binds the modalities of the mobile phone and input/output elements of a dialog description of the copier according to the first embodiment of the present invention;

FIG. 23 shows an example of the arrangement of a UI of a copier according to the fifth embodiment of the present invention;

FIG. 24 schematically expresses the schema description of modalities of the copier according to the fifth embodiment of the present invention;

FIG. 25 schematically expresses the schema description of modalities of the copier by a UI developer according to the fifth embodiment of the present invention;

FIG. 26 schematically expresses a dialog layer of the copier according to the fifth embodiment of the present invention;

FIG. 27 partially schematically expresses the description of a bind layer according to the fifth embodiment of the present invention;

FIG. 28 partially schematically expresses the description of a bind layer according to the fifth embodiment of the present invention;

FIG. 29 partially schematically expresses the description of a bind layer according to the fifth embodiment of the present invention;

FIG. 30 is a functional block diagram of the copier according to the fifth embodiment of the present invention;

FIG. 31 is a block diagram showing the hardware arrangement of the copier according to the fifth embodiment of the present invention;

FIG. 32 is a flow chart showing the process executed by the copier according to the fifth embodiment of the present invention;

FIG. 33 is a diagram of an information processing system according to the sixth embodiment of the present information;

FIG. 34 is a functional block diagram of the information processing system according to the sixth embodiment of the present information;

FIG. 35 shows an example of information to be transmitted from a copier to a mobile phone according to the sixth embodiment of the present invention;

FIG. 36 shows an example of information to be transmitted from the mobile phone to the copier according to the sixth embodiment of the present invention;

FIG. 37 shows an example of a remote controller used to control an air-conditioner according to the seventh embodiment of the present invention;

FIG. 38 schematically expresses a dialog layer unique to a control device according to the seventh embodiment of the present invention;

FIG. 39 schematically expresses the description of event information according to the eighth embodiment of the present invention;

FIG. 40A shows an XML expression example of a copier modality schema according to the fifth embodiment of the present invention;

FIG. 40B shows an XML expression example of a copier modality schema according to the fifth embodiment of the present invention;

FIG. 41A shows an XML expression example of a copier dialog layer newly defined by a UI developer according to the fifth embodiment of the present invention;

FIG. 41B shows an XML expression example of a copier dialog layer newly defined by a UI developer according to the fifth embodiment of the present invention;

FIG. 41C shows an XML expression example of a copier dialog layer newly defined by a UI developer according to the fifth embodiment of the present invention;

FIG. 41D shows an XML expression example of a copier dialog layer newly defined by a UI developer according to the fifth embodiment of the present invention;

FIG. 42A shows an XML expression example of a copier dialog layer according to the fifth embodiment of the present invention;

FIG. 42B shows an XML expression example of a copier dialog layer according to the fifth embodiment of the present invention;

FIG. 42C shows an XML expression example of a copier dialog layer according to the fifth embodiment of the present invention;

FIG. 43A shows an XML expression example of a copier bind layer according to the fifth embodiment of the present invention;

FIG. 43B shows an XML expression example of a copier bind layer according to the fifth embodiment of the present invention;

FIG. 43C shows an XML expression example of a copier bind layer according to the fifth embodiment of the present invention;

FIG. 43D shows an XML expression example of a copier bind layer according to the fifth embodiment of the present invention;

FIG. 44 shows an XML expression example of a mobile phone modality schema according to the sixth embodiment of the present invention;

FIG. 45 shows an XML expression example of a bind layer that binds the modalities of a mobile phone and the input/output elements of a dialog description of a copier according to the sixth embodiment of the present invention;

FIG. 46A shows an XML expression example of a dialog layer unique to a control device according to the seventh embodiment of the present invention; and

FIG. 46B shows an XML expression example of a dialog layer unique to a control device according to the seventh embodiment of the present invention.

### DETAILED DESCRIPTION OF THE PREFERRED EMBODIMENTS

Preferred embodiments of the present invention will be described in detail hereinafter with reference to the accompanying drawings.

[First Embodiment]

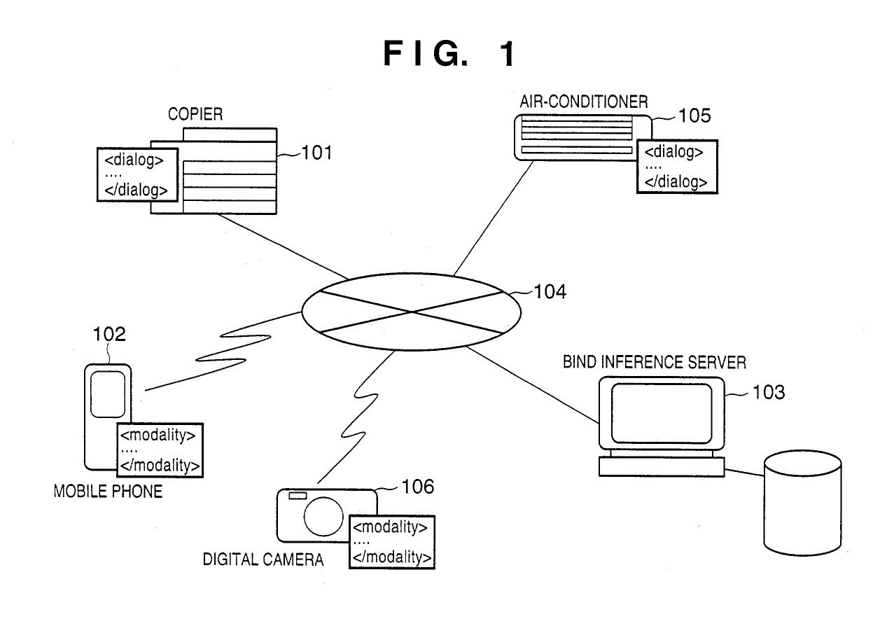

The first embodiment will exemplify a case wherein a copier (copying machine) is operated by a mobile phone via a network, as shown in FIG. 1.

FIG. 1 is a diagram of an information processing system according to the first embodiment of the present invention.

Referring to FIG. 1, reference numeral 101 denotes a copier as one of devices to be controlled. Reference numeral 102 denotes a mobile phone that the user uses as a control device.

Reference numeral 103 denotes a bind (layer) inference server which infers how to bind the modalities of the control device to the input/output elements of a dialog description of the device to be controlled, and automatically generates a bind layer.

Reference numeral 104 denotes a network such as the Internet, dedicated line, wireless network, optical fiber network, or the like. Reference numeral 105 denotes an air-conditioner as one of devices to be controlled. Reference numeral 106 denotes a digital camera that the user uses as a control device.

Note that respective devices which form the information processing system in FIG. 1 have at least a function of interpreting a markup language, and executing various processes based on the interpretation result.

The arrangement of the copier 101 will be explained below.

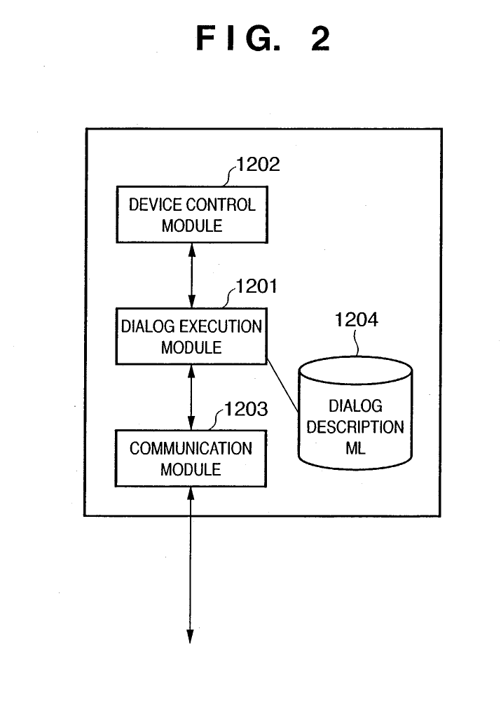

FIG. 2 is a functional block diagram of the copier according tot he first embodiment of the present invention.

Referring to FIG. 2, reference numeral 1201 denotes a dialog execution module which runs according to a description of a dialog layer of a markup language. Reference numeral 1202 denotes a device control module, which executes device control on the basis of a given instruction, when it receives an instruction associated with device control from the dialog execution module 1201 (e.g., executes a copy process in accordance with an instruction “start copy”) Reference numeral 1203 denotes a communication module which communicates with various devices via the network 104. Reference numeral 1204 denotes a dialog markup language (ML) that describes the dialog layer.

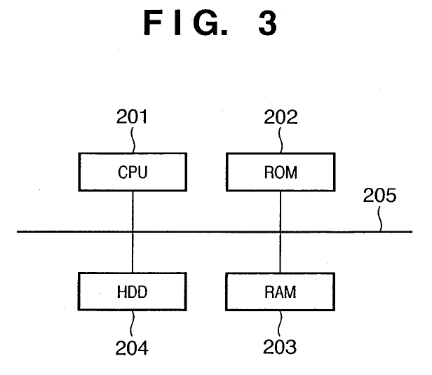

FIG. 3 is a block diagram showing the hardware arrangement of the copier according to the first embodiment of the present invention.

Referring to FIG. 3, reference numeral 201 denotes a CPU which operates in accordance with a program that implements the flow chart to be described later. Reference numeral 203 denotes a RAM, which provides a storage area, work area, and data temporary save area required to run the program. Reference numeral 202 denotes a ROM which holds the program that implements the flow chart to be described later, and various data. Reference numeral 204 denotes a disk device which holds various data of the dialog markup language 1204 and the like. Reference numeral 205 denotes a bus which interconnects the respective building components.

The arrangement of the mobile phone 102 will be described below.

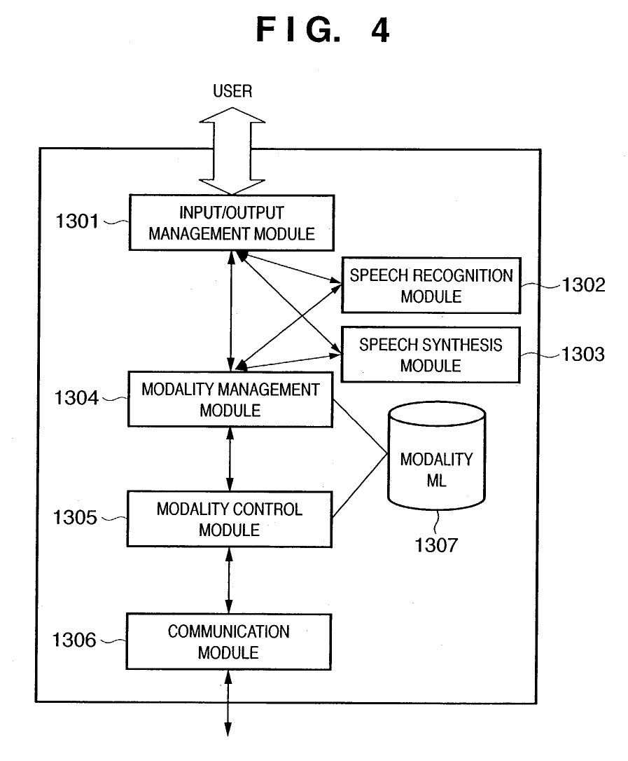

FIG. 4 is a functional block diagram of the mobile phone according to the first embodiment of the present invention.

Reference numeral 1301 denotes an input/output management module, which manages data input/output and speech input/output. Reference numeral 1302 denotes a speech recognition module, which recognizes input speech. Reference numeral 1303 denotes a speech synthesis module, which synthesizes speech of data to be output as speech. Reference numeral 1304 denotes a modality management module, which runs according to the description of a modality layer of a markup language, and manages modalities (UI parts). Reference numeral 1305 denotes a modality control module, which runs according to the description of a bind layer of a markup language. Reference numeral 1306 denotes a communication module which communicates with various devices via the network 104. Reference numeral 1307 denotes a modality markup language (ML), which describes the modality layer.

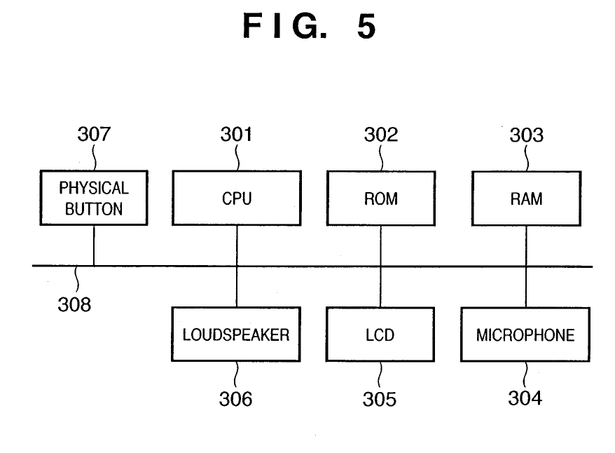

FIG. 5 is a block diagram showing the hardware arrangement of the mobile phone according to the first embodiment of the present invention.

Referring to FIG. 5, reference numeral 301 denotes a CPU which operates according to a program that implements the flow chart to be described later. Reference numeral 303 denotes a RAM which provides a storage area, work area, and data temporary save area required to run the program. Reference numeral 302 denotes a ROM which holds the program that implements the flow chart to be described later, and various data. Reference numeral 304 denotes a microphone, which is used to input speech to the speech recognition module 1302. Reference numeral 305 denotes a liquid crystal display device (LCD). Reference numeral 306 denotes a loudspeaker, which outputs speech synthesized by the speech synthesis module 1303. Reference numeral 307 denotes physical buttons used to execute various operations. Reference numeral 308 denotes a bus which interconnects the respective building components.

The arrangement of the bind layer inference server 103 will be described below.

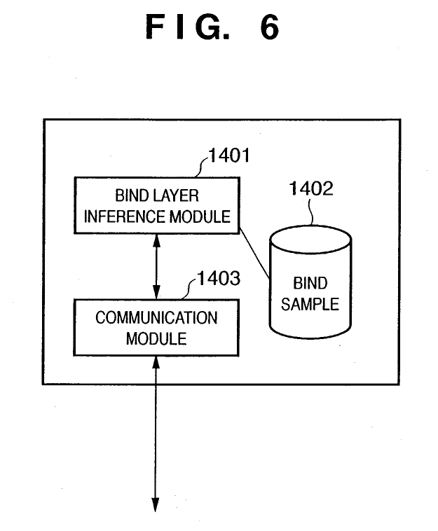

FIG. 6 is a functional block diagram of the bind layer inference server according to the first embodiment of the present invention.

Referring to FIG. 6, reference numeral 1401 denotes a bind layer inference module. Reference numeral 1402 denotes a bind sample which indicates a bind description sample used in inference in the bind layer inference module 1401. Reference numeral 1403 denotes a communication module which communicates with various devices via the network 104.

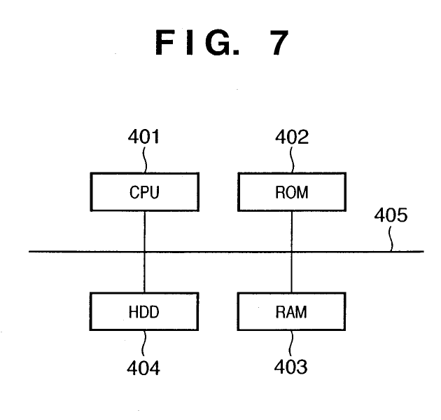

FIG. 7 is a block diagram showing the hardware arrangement of the bind layer inference server according to the first embodiment of the present invention.

Referring to FIG. 7, reference numeral 401 denotes a CPU which operates according to a program that implements the flow chart to be described later. Reference numeral 403 denotes a RAM which provides a storage area, work area, and data temporary save area required to run the program. Reference numeral 402 denotes a ROM which holds the program that implements the flow chart to be described later, and various data. Reference numeral 404 denotes a disk device which holds, e.g., various data of the bind sample 1402 and the like. Reference numeral 405 denotes a bus which interconnects the respective building components.

Prior to a description of practical operation examples, an example of the specification of a multi-modal user interface markup language (to be referred to as an MMML hereinafter) according tot he present invention will be explained.

<Three-Layered Structure>

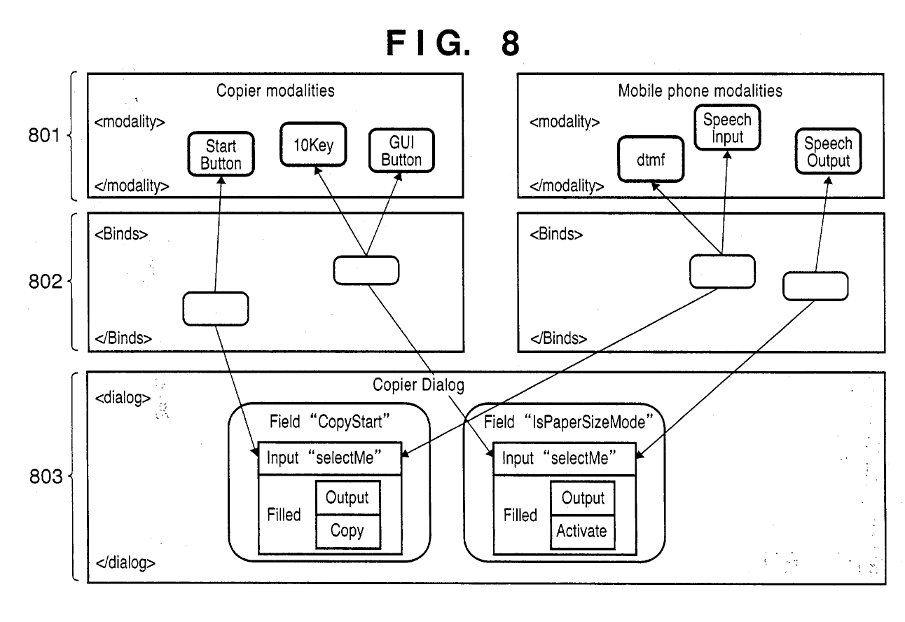

In the present invention, a modality description depending on devices, and a dialog description as UI logic are separately given, as shown in FIG. 8. Especially, the present invention adopts a three-layered structure which includes a bind layer 802 which indicates a description (bounded between tags <Binds> and </Binds>) that binds modalities and dialogs, in addition to a modality layer 801 which indicates a modality description (bounded between tags <modality> and </modality>) and a dialog layer 803 which indicates a dialog description (bounded between tags <dialog> and </dialog>).

Since the modality description is separated in this way, one dialog description (UI logic) can be shared by a plurality of devices of different modalities. FIG. 8 shows an example of this three-layered structure.

FIG. 8 shows the structure of a description (Mobile phone modalities) that allows operations from the mobile phone 102 in addition to a copier modality description (Copier modalities) that indicates operations of the copier 101, i.e., a description that pertains to operations by means of physical buttons, a GUI on the LCD, and the like of the copier 101, as the modality layer 801. As in this example, when one copier dialog description (Copier Dialog) is formed as the dialog description layer 803, operations from various devices are allowed by describing device-dependent modality layers 801 and bind layers 802 in correspondence with devices.

<Class and Instance of Modality>

In the description of the modality layer in the MMML, it is difficult to define all vocabulary data that express respective modalities, i.e., UI parts in advance as defined terms of the MMML, and such definitions result in poor expandability if that is possible. Hence, classes of some kinds of UI parts which are expected to be generally used are defined as an MMML command vocabulary, and a new class can be defined by succeeding this class. Furthermore, UI parts used in an actual UI description can be defined as instances of such classes. As a method of describing definition and succession of classes, the hierarchical relationship among classes, and definition of instances in XML, the first embodiment uses an RDF schema. The RDF schema is a markup language (see http://www.w3.org/TR/rdf-schema/) standardized by W3C (see http://www.w3.org) as a standardization group of Web.

<Schema of Generic Modality Class>

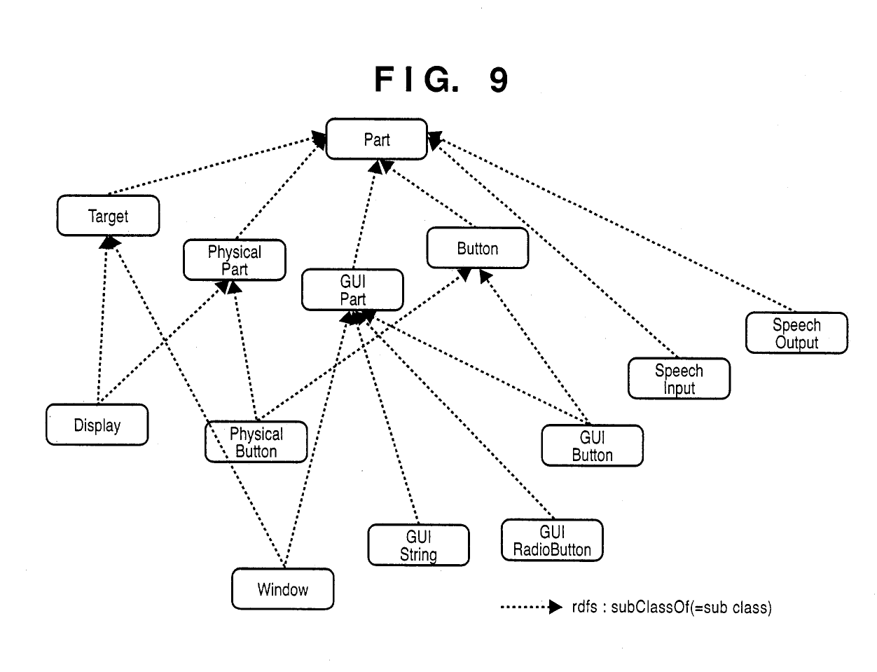

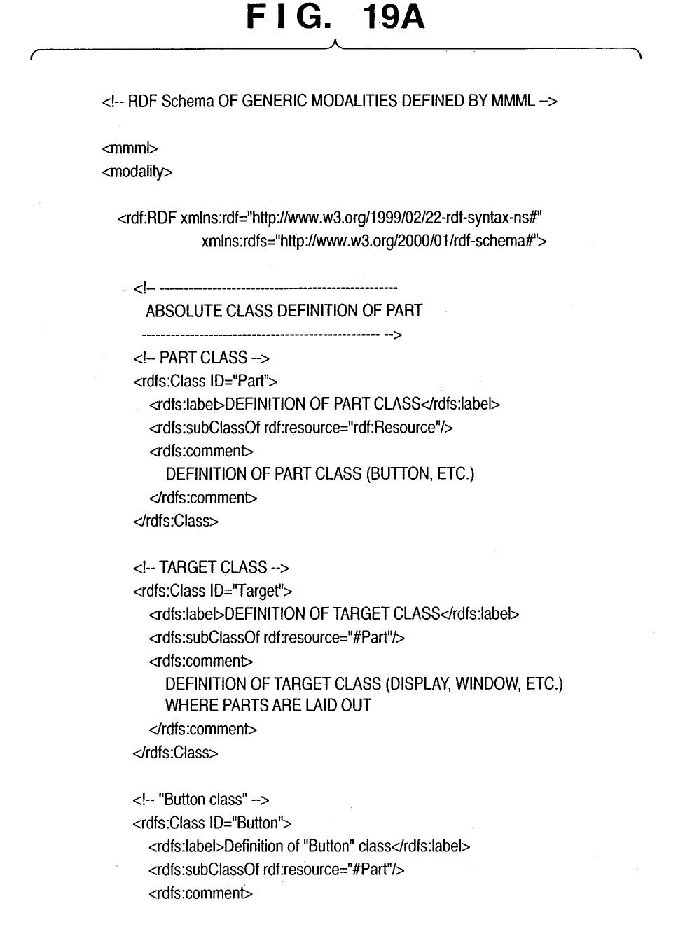

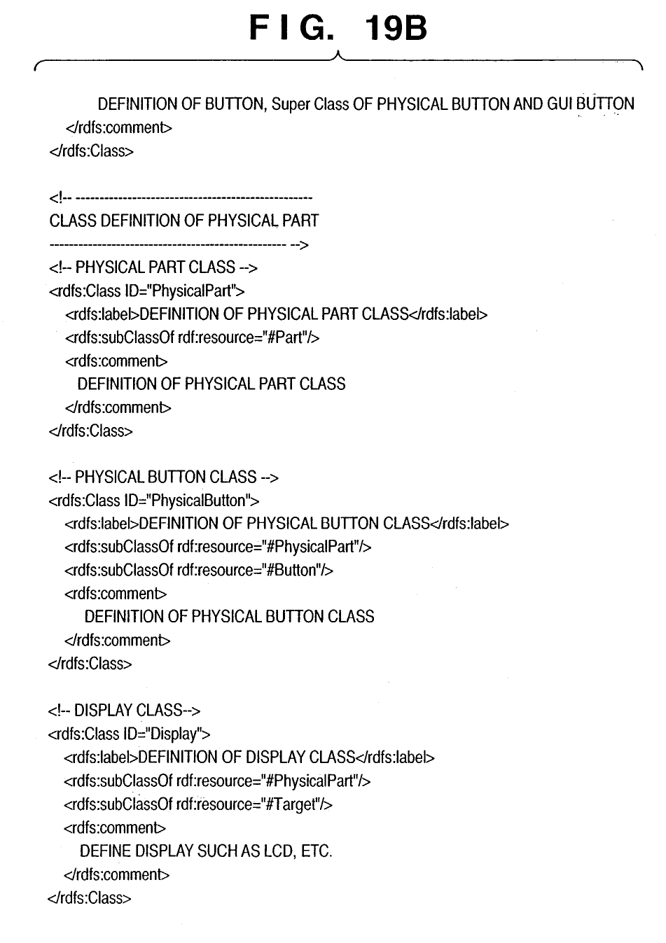

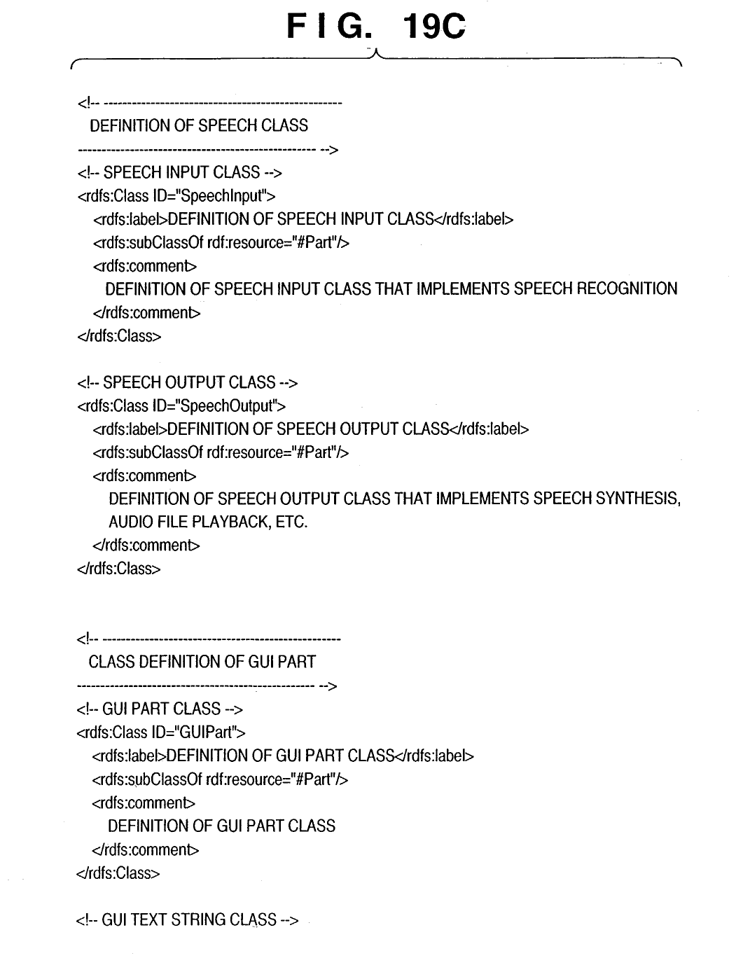

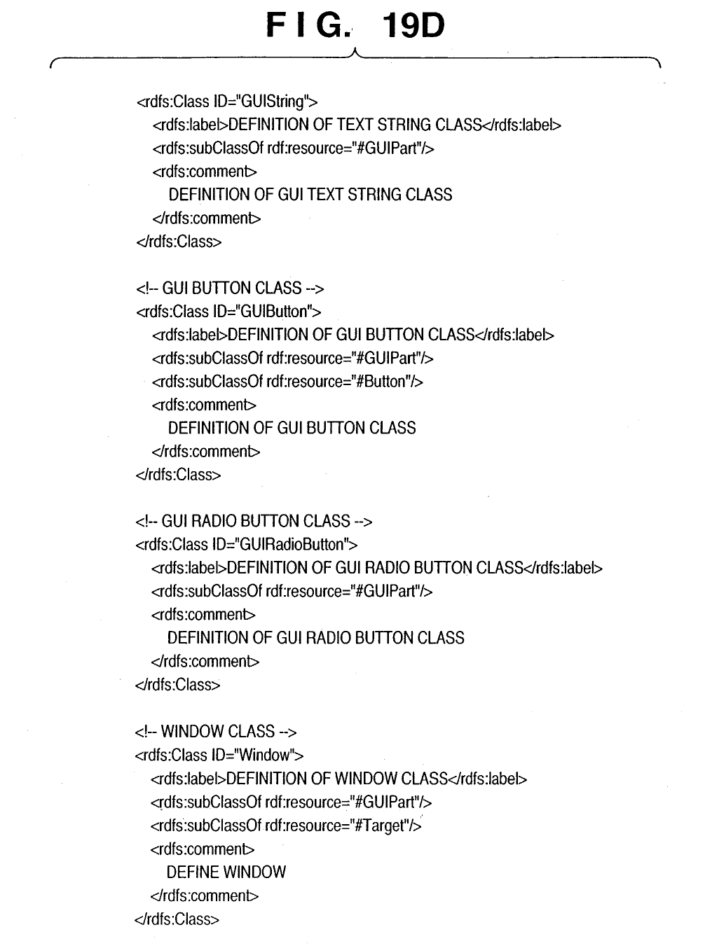

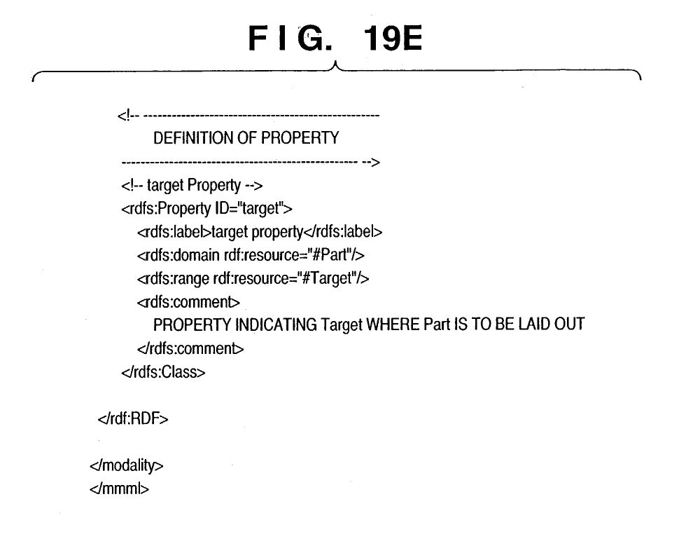

Some kinds of GUI parts classes which are expected to be used generally are defined as an MMML vocabulary in the form of the RDF schema. FIG. 9 schematically expresses this RDF schema (generic modality schema). As shown in FIG. 9, UI part classes can he hierarchically defined using the RDF schema. For example, “Button” can define “Physical Button” and “GUI Button” as sub-classes. The former includes, e.g., buttons of the copier, and the later include, e.g., buttons displayed on a liquid crystal panel. The XML expression of this RDF schema is as shown in FIGS. 19A to 19E.

<Modality Schema of Control Device (Client)>

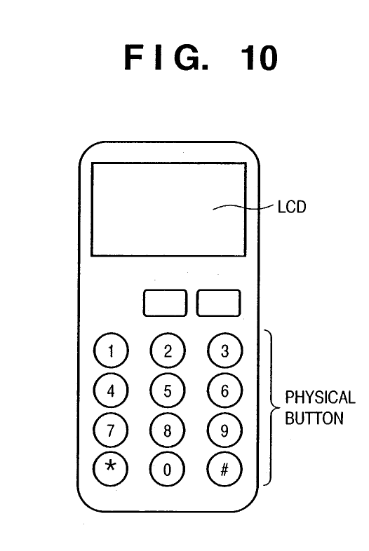

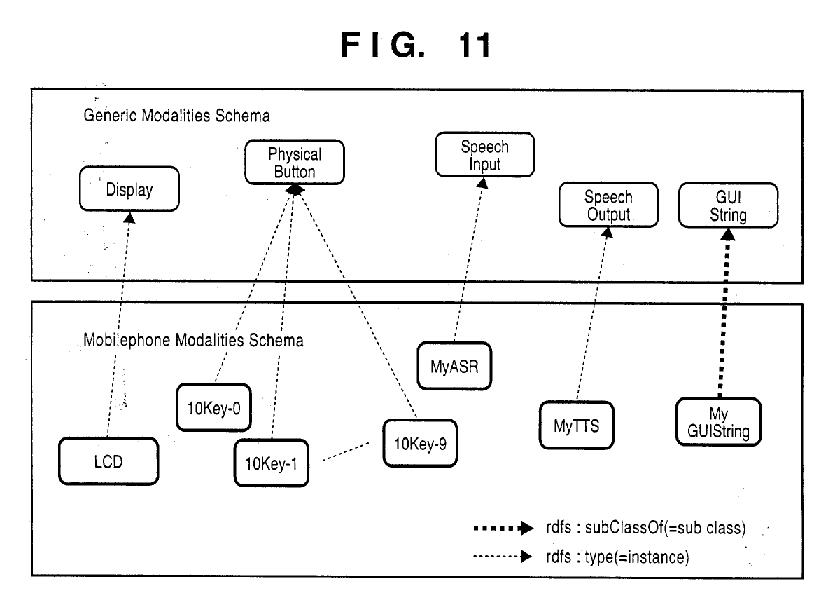

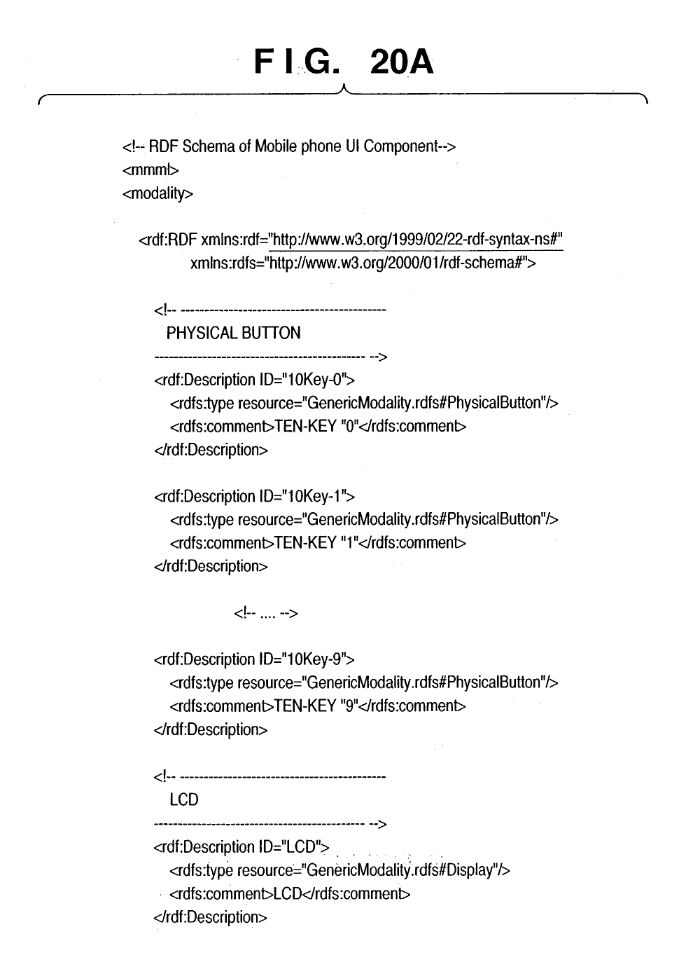

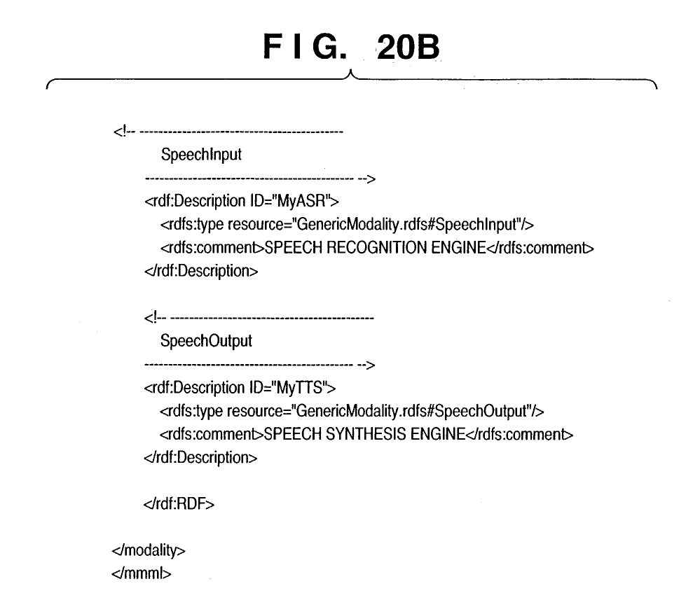

A schema that defines control device-dependent UI part classes and instances is described on the basis of generic UI part classes defined as the MMML common vocabulary. That is, this modality schema describes modalities which are available in a given control device, and is assumed to be provided by the manufacturer of that control device. For example, FIG. 11 schematically expresses a mobile phone modality schema (Mobilephone Modalities Schema) corresponding to UI parts (an LCD, physical buttons, speech input, speech output, and the like) of the mobile phone shown in FIG. 10 in association with a generic modality schema (Generic Modalities Schema). The XML expression of this modality schema is as shown in FIGS. 20A and 20B.

<Dialog Layer>

This layer gives a practical dialog description, and allows a description independent from modalities. In the MMML description, the dialog layer is described within tags <dialog> and </dialog>. The minimum unit of dialog is [field] (minimum dialog unit). [Field] has input/output elements [input] and [output], and an element [filled].

The input and output elements are tags used to describe information to be input/output, and have IDs as attributes. This ID is used to describe binding to a modality described separately. This will be explained later.

<[Input] Element>

This element describes the type of input to be accepted by [field] to which that element belongs. The type of input is described in a [type] attribute. The following attribute values are defined in advance as the MMML common vocabulary.

“selectMe”

This is a type of input which accepts the fact that input has been made. This type can bind modalities such as “button”, speech, and the like.

“selectOne”

This is a type of input which selects one of choices. For example, a radio button, pull-down menu, and the like are typical modalities. An input element of selectOne type describes choices using [item] tags. A modality such as “button” or the like can be bound to each [item].

“selectMany”

This is a type of input which selects a plurality of ones of choices. For example, a combo box (ComboBox) or the like is a typical modality. The element of this type describes choices using [item] tags as in selectOne type.

“TextString”

This is a type of input which accepts input of a text string. For example, a text box of a GUI and speech input are typical modalities.

<[Output] Element>

This element describes output of [field] to which that element belongs. The output contents can be described using [content] tags.

<[filled] Element>

This element describes an action (action information) in response to input to each [field]. Various types of actions are available. A typical action includes interaction with an internal program other than a UI by script description or some other description methods (e.g., a processing program that actually copies is launched upon reception of input of “copy start”), and the like. [Output] tags can be described in the [filled] tag when a response is made with respect to an input.

<Role of [Fields]>

The role of [fields] is to group [field]s. In general, the state of UI logic is divided into some groups, and UI logic is defined for each group in many cases. Hence, it is convenient to form appropriate groups using [fields] (e.g., a default window and respective setup windows of the copier).

<Example of Dialog Layer of Copier>

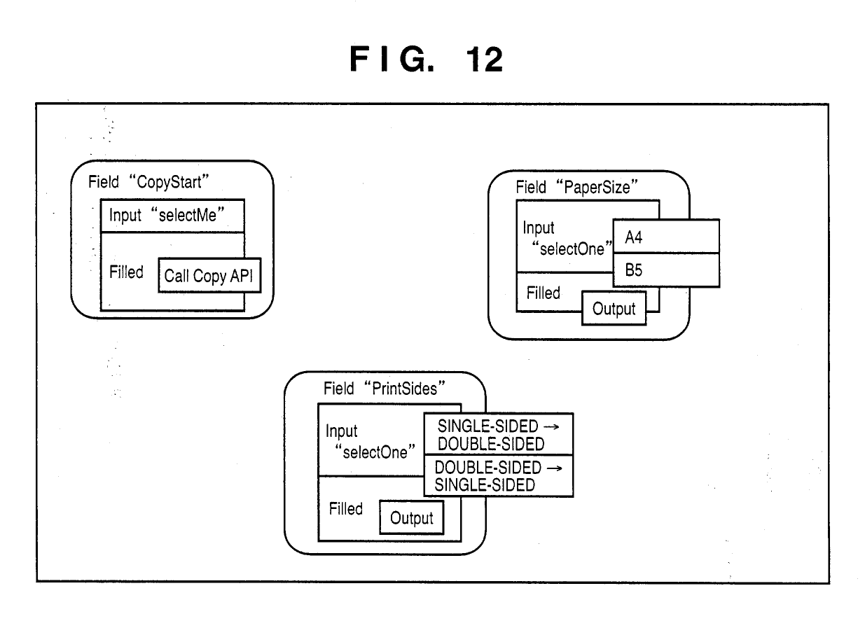

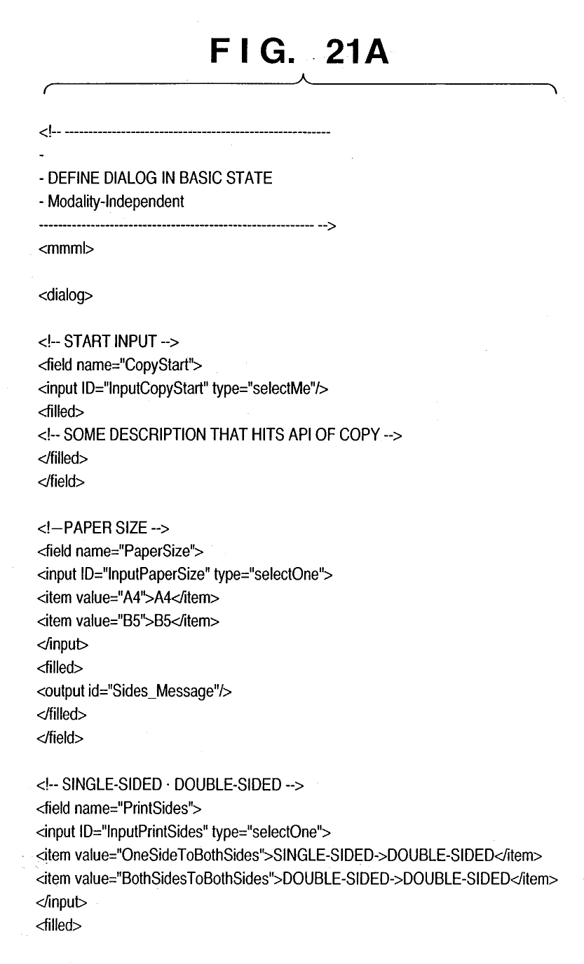

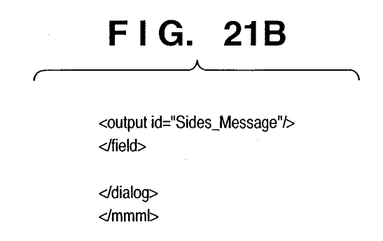

FIG. 12 shows a description example of the dialog layer of the copier UI, and FIGS. 21A and 21B show its XML expression.

This example describes a UI that designates execution of copy (CopyStart), paper size (PaperSize), and single-/double-sided (PrintSides). Note that this example gives no modality description, i.e., does not describe any UI parts (button input, speech input, text display, speech output, and the like) to be practically used (modality-independent).

<Bind Layer>

Since the modality-independent dialog description excludes any modalities, modalities and the dialog description must be associated with each other. The bind layer describes such association, and binds respective modalities defined in the modality layer to respective input/output elements in the dialog layer. Binding is described by referring to the IDs of modalities and input/output elements to be bound using URIs (Uniform Resource Identifiers). The bind layer is described within tags <Binds> and </Binds>. Respective bind elements are described within tags <Binds> and </Binds>. By binding a plurality of modalities to one input/output element in the dialog layer, a multi-modal UI that uses selective or coordinated use of a plurality of modalities can be described. The bind layer allows the following descriptions that pertain to modality management.

description of combining method of a plurality of modalities

description of output contents

description of activate/deactivate of modalities

<Description of Combining Method of a Plurality of Modalities>

When a plurality of modalities are bound to one input/output element, a combining method of modalities such as selective use, coordinated use, or the like can be instructed. The binding method instruction is described in a BindType attribute. The following attribute values of the BindType attribute are defined in advance as the MMML common vocabulary.

“Alt”

One of a plurality of modalities bound to an input/output element can be used. Assume that the priority order of a plurality of modalities is an order in which they are described. For example, if the modality of a radio button and the modality of speech input are bound to an input element that selects a paper size “A4 or B5” in the copier via the “Alt” attribute, this means that the paper size can be selected by either the radio button or speech input.

“Seq”

A plurality of modalities bound to an input/output element are applied sequentially. For example, such modalities correspond to inputs like “utter after button A is pressed”.

“Coordinated”

A plurality of modalities bound to an input/output element are coordinated. For example, such modalities correspond to inputs like pointing to “Osaka” on a displayed map using a pointing device while uttering “from Tokyo to here”. A coordinated operation to be attained depends on the specification of a browser which executes the MMML, and is not specified by the present invention.

<Description of Output Contents>

The output contents can be described in a bind element that binds output elements of the dialog layer. The output contents may be written immediately inside tags <Binds> and </Binds>, or may be written inside each modality description to be bound. In this manner, the output contents corresponding to a modality can be described appropriately.

For example, a description that sets a message “copy is complete” as the output contents of a speech synthesis modality, and assigns a file name of an audio file that produces a beep tone to an alarm tone playback modality can be given. As described above, the output contents can be described in the output element of the dialog layer (inside tags <output>and </output>. The priority order of these description is:

“inside modality description in bind element>immediately inside bind element>inside output element of dialog layer”

<Description of Activate/Deactivate of Modality>

Each bound modality can be activated/deactivated. For example, a description that deactivates a speech input modality when ambient noise is large can be given. Activate and deactivate are described respectively using <activate modality=“ . . . ”/> and <deactivate modality=“ . . . ”/>.

<Example of Bind Layer>

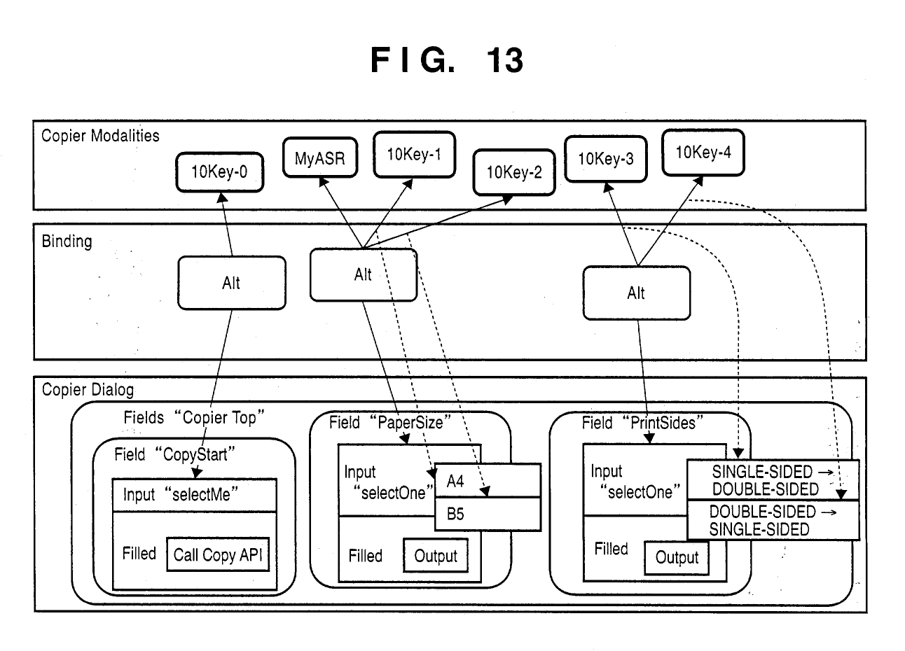

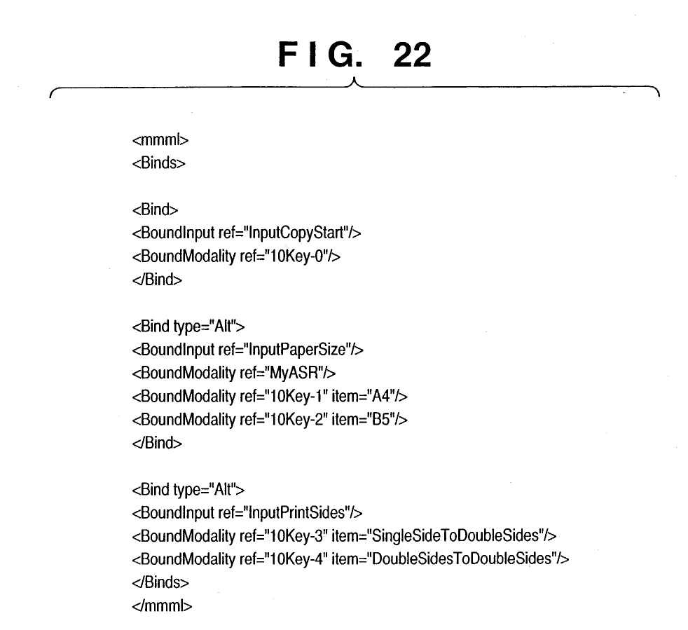

FIG. 13 shows an example of a bind layer which binds the modality description (FIG. 11) of the mobile phone 102 and the dialog description (FIG. 12) of the copier in order to operate the copier 101 from the mobile phone 102. Furthermore, FIG. 22 shows its XML expression.

In this manner, in the present invention, since the bind inference server 103 automatically generates a bind layer with respect to an arbitrary modality layer and an arbitrary dialog layer, an arbitrary control device (e.g., mobile phone 102) is allowed to operate an arbitrary device to be controlled (copier 101).

<Example Upon Operating Copier from Mobile Phone>

An example upon operating the copier 101 from the mobile phone 102 in accordance with the specification of the markup language with the aforementioned specification will be explained below.

Note that the mobile phone 102 holds the markup language that has the modality layer shown in FIG. 11. Assume that such markup language is normally prepared by the manufacturer of the mobile phone 102, and is installed in the mobile phone upon delivery. On the other hand, the copier 101 holds the markup language having the dialog layer shown in FIG. 13. Assume that such markup language is normally prepared by the manufacturer of the copier 101, and is installed in the copier upon delivery.

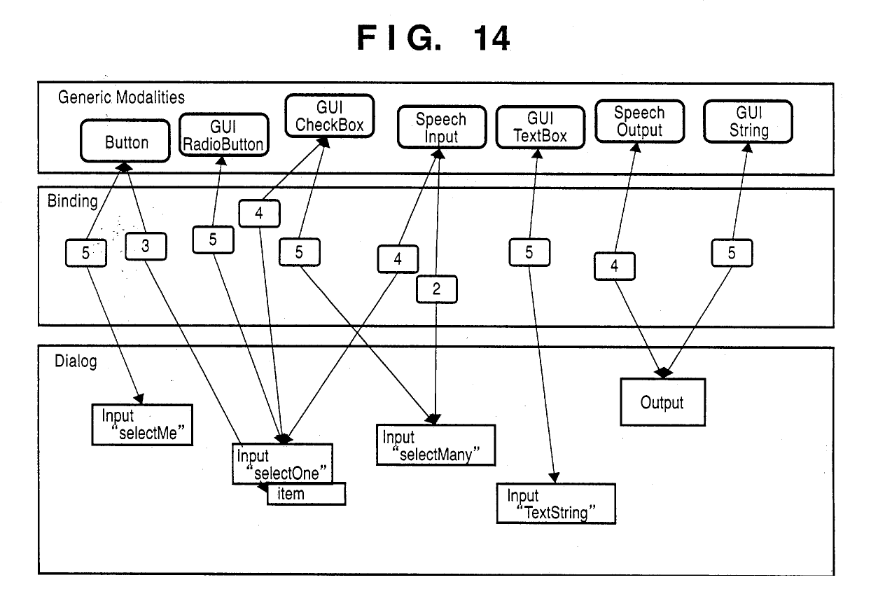

The bind layer inference server 103 holds a bind sample shown in, e.g., FIG. 14. This bind sample indicates appropriate level information indicating if generic modalities defined by the schema shown in FIG. 9 can be bound to input/output elements, and indicating the appropriate level of a given modality (each numerical value (ranging from 1 to 5) of the bind layer in FIG. 14 indicates the appropriate level, which becomes higher with increasing numerical value).

For example, a modality “Button” can be bound to an input element of “selectMe” type with appropriate level “5”, and can also be bound to respective items of an input element of “selectOne” type with appropriate level “3”. The former defines correspondence “start copy if a start button of the copier is pressed”, and the latter defines correspondence “of items “Tokyo”, “Osaka”, and “Nagoya”, if button A is pressed, “Tokyo” is selected”; if button B, “Osaka”; and if button C, “Nagoya”.

On the other hand, a modality “GUIRadioButton” can be bound to an input element of “selectOne” type with appropriate level “5”. For this reason, if a control device comprises UI parts of both “Button” and “GUIRadioButton” classes, it is more appropriate to bind a modality of “GUIRadioButton” class to an input element of “selectOne” type since its appropriate level is “5”.

The bind layer inference server 103 binds the modalities of an actual control device and input/output elements of a device to be controlled on the basis of such bind sample. A practical operation example will be described in detail below.

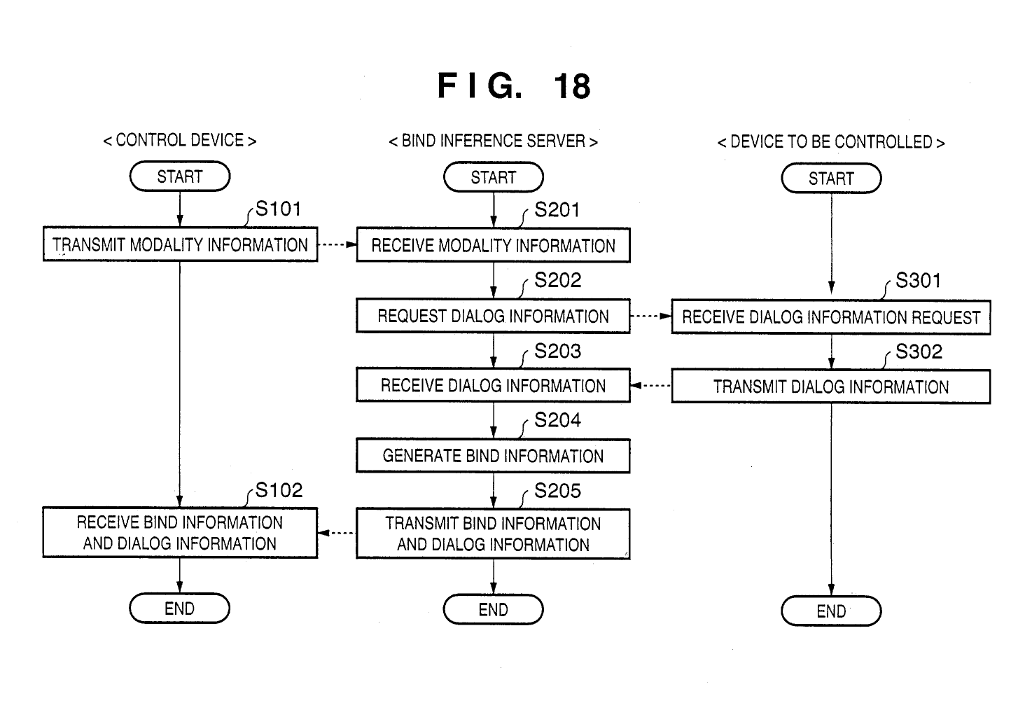

FIG. 18 is a flow chart showing the process executed by the bind layer inference server according to the first embodiment of the present invention.

When the user wants to operate the copier 101 (device to be controlled) in his or her office using the mobile phone 102 (control device) at a remote place where he or she visited, the user transmits modality information that contains the URL of the copier 101 and the modality layer (FIG. 11) of the mobile phone 102 to the bind layer inference server 103 in step S101.

The bind layer inference server 103 receives the modality information from the mobile phone 102 in step S201. The server 103 issues a transmission request of dialog information that contains a dialog description to the copier 101 on the basis of the URL contained in the received modality information in step S202.

Upon reception of this request from the bind inference server 103, the copier 101 transmits dialog information associated with its own dialog layer (FIG. 12) to the bind inference server 103 in step S301.

The bind layer inference server 103 receives the dialog information from the copier 101 in step S203. In step S204, the bind layer inference module 1401 determines the modalities of the mobile phone 102 to be bound to the respective input/output elements of the dialog description in the dialog information. More specifically, bind information that contains a bind layer which binds the modality description of the mobile phone 102 and the dialog description of the copier 101 is generated as follows with reference to a bind sample 1402 (FIG. 14).

For example, since an input element of “CopyStart” [field] in the dialog description of the copier 101 is of “selectMe” type, an appropriate modality to be bound to this element is a modality of “Button” class, as can be seen from FIG. 14. Also, as can be seen from FIGS. 9 and 11, instances of lower classes of “Button” class among the modalities of the mobile phone 102 are “10Key-0” to “10Key-9” of ten-keys (0 to 9). Thus, “10Key-0” as appropriate one of these keys is bound to the input element of “CopyStart” field.

Likewise, since an input element of “PaperSize” field is of “selectOne” type, a modality of “GUIRadioButton”, “GUICheckBox”, or “SpeechInput” class, or a modality of “Button” class is bound to respective items, as can be seen from FIG. 14. As can be seen from FIGS. 9 and 11, of the modalities of the mobile phone 102, a speech input modality, i.e., “MyASR”, or ten-keys “10Key-0” to “10Key-9” are to be bound.

Since “10Key-0” has already been bound, “10Key-1” and “10Key-2” are respectively bound to items “A4” and “B5”. In this manner, a multi-modal interface that allows both speech input and button input can be formed by also binding “MyASR”.

Note that the recognition vocabulary of speech input modality “MyASR” automatically generates “A-four” and “B-five” from the items. Such automatic generation can be implemented by a pronunciation assignment process using language analysis from the descriptions “A4” and “B5” of the items. Note that the pronunciation assignment process can be implemented by a technique used in speech synthesis or the like, and its detailed contents fall outside the scope of the present invention.

The same applies to input elements of “PrintSides” field. That is, “10Key-3” and “10Key-4” are bound to items, and speech input modality “MyASR” is also bound. In this manner, bind information that contains the bind layer shown in FIG. 13 is generated. The bind layer inference server 103 transmits this bind information containing the bind layer to the mobile phone 102 together with the dialog information that contains the dialog layer (FIG. 12) of the copier 101.

In this way, the mobile phone 102 can have the markup language in which its own modalities are bound to the dialog description of the copier 101 via the bind layer, and can execute various operations of the copier 101 on the basis of this markup language.

An operation example between the mobile phone 102 and copier 101 will be explained below.

After the mobile phone 102 receives the bind layer and dialog layer from the bind inference server 103, if the user has pressed a ten-key “1” of the mobile phone 102, the input/output management module 1301 of the mobile phone 102 detects this input. As a result of this detection, the modality management module 1304 detects an input via modality “10Key-1”.

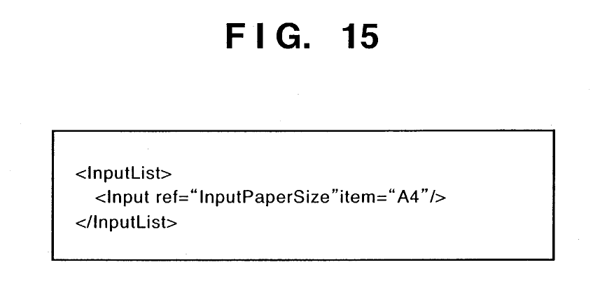

The modality control module 1305 can recognize with reference to the bind layer description (FIG. 13) received from the bind layer inference server 103 that this modality is bound to item “A4” of the input element of “PaperSizes” field of the copier 101. Hence, the module 1305 transmits this information to the copier 101 as XML data shown in FIG. 15 via the communication module 1306.

The copier 101 receives the XML data shown in FIG. 15 via the communication module 1203, and the dialog execution module 1201 interprets the contents of that data, thus detecting that the paper size is set to be “A4”. Subsequently, when the user has pressed a ten-key “0”, the input/output management module 1301 of the mobile phone 102 detects this input, and the modality management module 1304 detects the input via modality “10Key-0”.

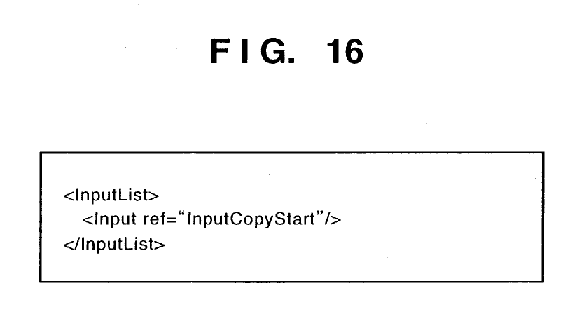

The modality control module 1305 can recognize with reference to the bind layer description (FIG. 13) received from the bind layer inference server 103 that this modality is bound to the input element of “CopyStart” field of the copier 101. Hence, the module 1305 transmits this information to the copier 101 as XML data shown in FIG. 16 via the communication module 1306.

The copier 101 receives the XML data shown in FIG. 16 via the communication module 1203, the dialog execution module 1201 interprets the contents of that data, and the device control module 1202 starts a copy process.

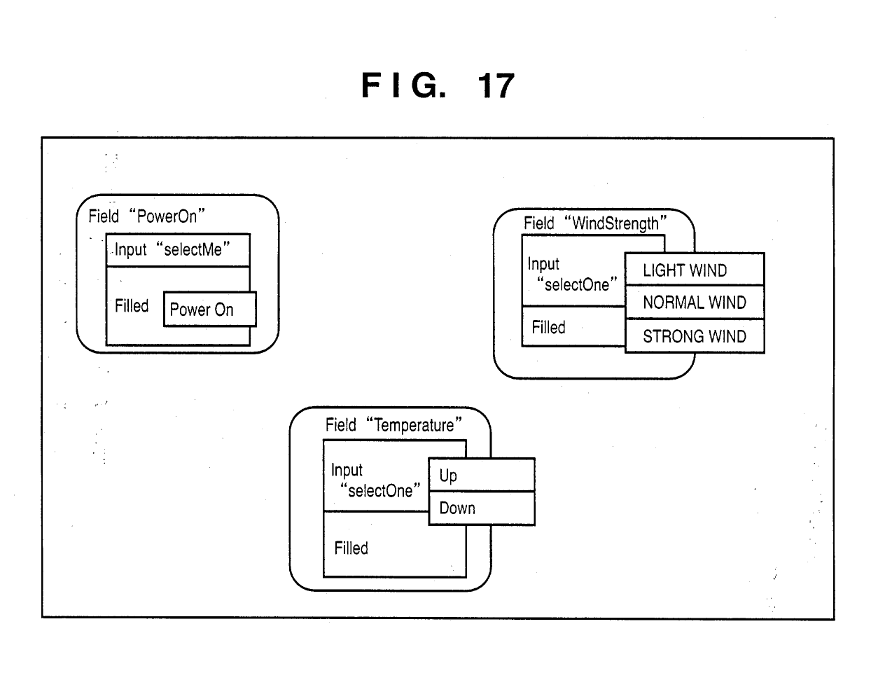

As described above, the bind layer inference server 103 binds the modalities of a control device (e.g., mobile phone 102) and the input/output elements in a dialog description of a device to be controlled (e.g., copier 101). Hence, even when the user has changed the control device to the digital camera 106, the copier 101 can be similarly controlled as long as the digital camera 106 forms its own modality description, and the same functions as those in FIG. 4. Even when the air-conditioner 105 is a device to be controlled, it can be similarly controlled as long as the air-conditioner forms a dialog description (FIG. 17) as its own control sequence, and the same functions shown in FIG. 2.

As described above, according to the first embodiment, in an environment in which processes associated with a control device and a device to be controlled are implemented based on a markup language, this markup language especially includes,

a dialog description of the device to be controlled,

a modality description of the control device, and

a bind description that binds these dialog and modality descriptions.

The control device comprises a modality management module that makes input/output management in accordance with the contents of the modality description in the markup language, and a modality control module that exchanges information between respective modalities and input/output elements bound to them in accordance with the description of a bind layer in the markup language.

The device to be controlled comprises a dialog execution module that accepts inputs from respective modalities managed by the modality management module, and executes instructions of outputs to respective modalities in accordance with the contents of the dialog description in the markup language.

A bind inference server comprises a bind inference module which exchanges information between respective modalities and input/output elements bound to them in accordance with the contents of the bind description of the markup language.

In this way, an arbitrary device can be automatically formed as a control device which controls an arbitrary device. Also, that control device can be formed as the one which comprises a multi-modal user interface.

[Second Embodiment]

In the first embodiment, the mobile phone and digital camera have been exemplified as the control devices, and the copier and air-conditioner have been exemplified as the devices to be controlled. However, arbitrary devices (e.g., a PDA, remote controller, and the like) can serve as control devices to control other arbitrary devices (OA devices such as a facsimile, printer, scanner, and the like, home electric appliances such as an electric pot, refrigerator, television, and the like) as devices to be controlled.

[Third Embodiment]

In the first embodiment, the Internet is used as the network that interconnects the devices. However, any other types of networks and protocols may be used as long as they can exchange text information described in XML.

[Fourth Embodiment]

In the first embodiment, the bind layer inference module 1401 is formed on the bind layer inference server 103. However, the bind layer inference module 1401 may be formed on the control device (client) to generate a bind description between its own modalities and a dialog description of a device to be controlled.

[Fifth Embodiment]

The aforementioned dialog description can be roughly categorized into three types, i.e., user-oriented type, system-oriented type, and mixed-oriented type. User-oriented type allows the user to select an input/output procedure, and corresponds to, e.g., HTML-based Web browsing in which the user fills blanks of a form, and presses buttons.

On the other hand, in system-oriented type, the system determines an input/output procedure, and the user carries on inputs in accordance with system instructions. For example, an installer of wizard type corresponds to this type, and an arrangement in which the user inputs speech along with the speech guidance of the system or makes inputs based on DTMF like in a CTI system is also an example of this system-oriented type.

Mixed-oriented type is a combination of these user- and system-oriented types. VoiceXML is designed to allow system- and mixed-oriented descriptions. In order to implement a UI description with higher versatility, it is desirable to allow a UI developer to freely describe a dialog strategy irrespective of a user-, system-, or mixed-oriented description. However, existing markup languages such as HTML, WML, VoiceXML, and the like are dominated by one of these types of descriptions.

On the other hand, the modality description depends on the client form, as described above.

In consideration of existing markup languages, HTML basically assumes a GUI as a modality. VoiceXML assumes speech and DTMF as modalities. These markup languages are modality-dependent ones, and are not suitable for a multi-modal user interface that combines a plurality of modalities.

For example, since CML as a markup language described in the prior art does not allow a UI developer to describe how to combine a plurality of modalities, it cannot exert any merits as a multi-modal user interface. For example, CML cannot give descriptions which define different operations when the user utters while pressing button A or B. Also, the UI developer cannot customize or control modalities using a description of the markup language. For example, a description that deactivates a speech input modality when ambient noise is large cannot be given.

Hence, in the fifth embodiment, an information processing apparatus, its control method, and a program which can implement modality control that has higher versatility and allows easy expansion will be explained.

A specification example of a multi-modal user interface markup language (to be referred to as an MMML hereinafter) as a characteristic feature of the present invention will be explained first. Especially, a case will be exemplified wherein the UI of a copier is implemented.

In this specification example, a description of the same specification example as in the first embodiment will be omitted.

<Modality Schema of Control Device (Client)>

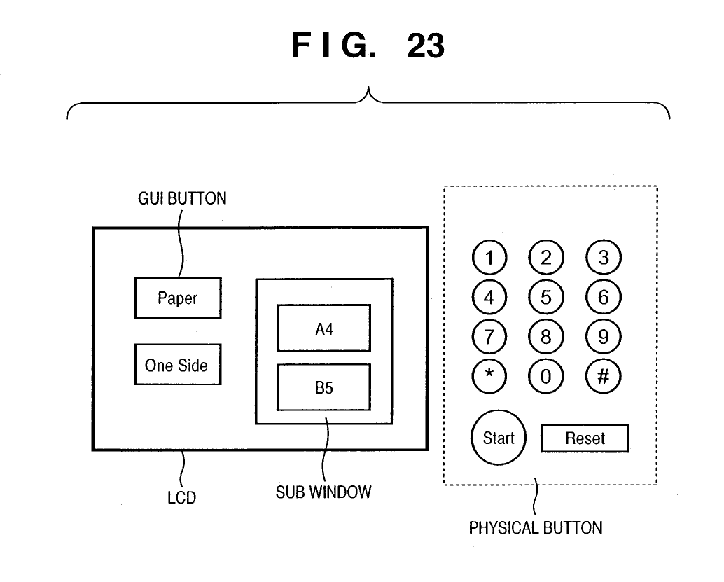

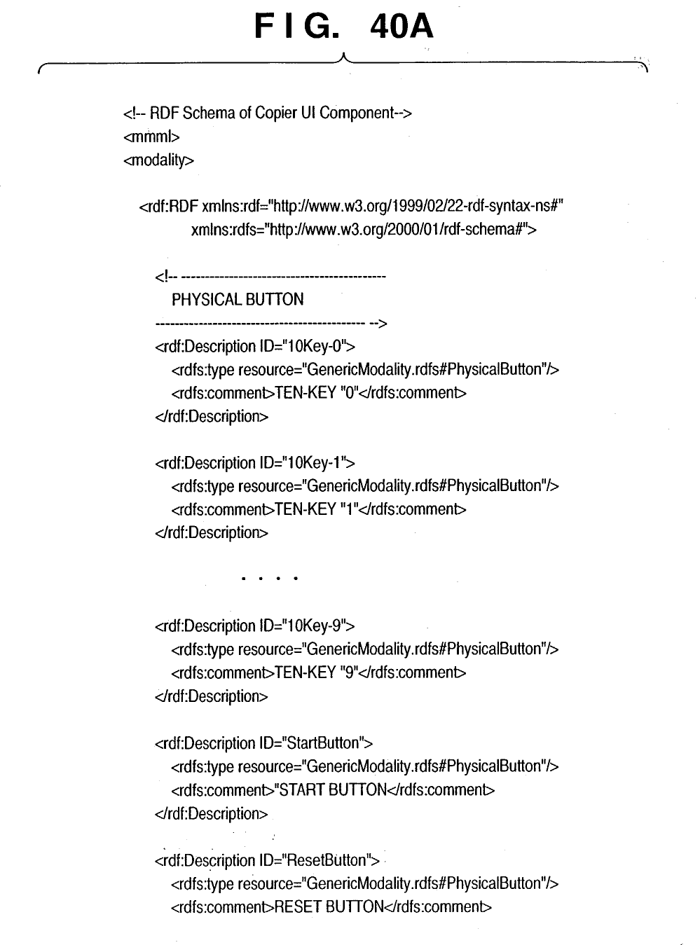

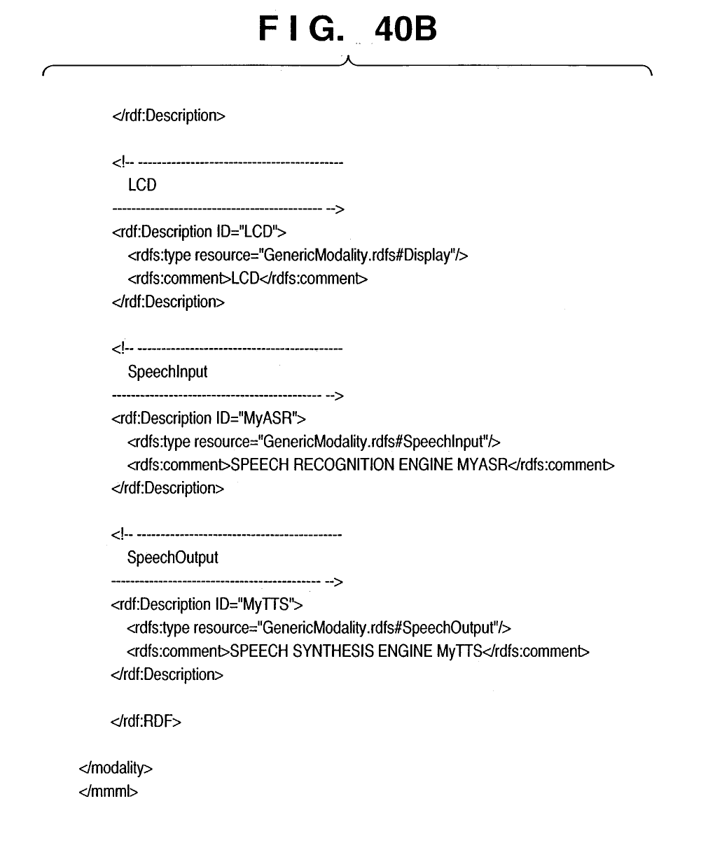

A schema which defines control device-dependent UI part classes and instances on the basis of generic UI part classes defined as an MMML common vocabulary is described. That is, this modality schema describes modalities which are available in a given control device, and is assumed to be provided by the manufacturer of that control device. For example, FIG. 23 schematically expresses a modality schema corresponding to UI parts (LCD, physical buttons, speech input, speech output, and the like) of a copier shown in FIG. 23. FIGS. 40A and 40B show an XML expression of this modality schema.

<Expansion of Modality by UI Developer>

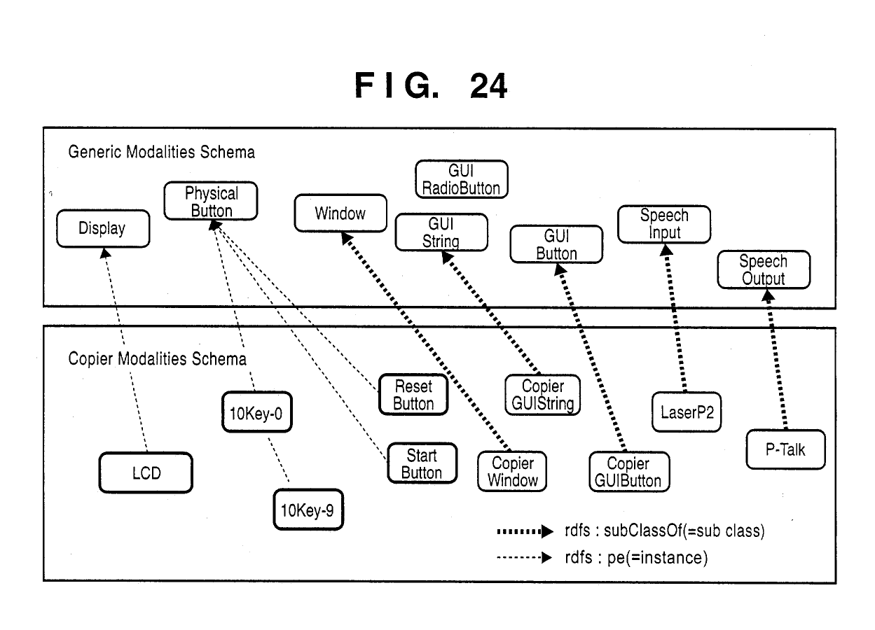

In a copier modality schema (Copier Modalities Schema) corresponding to the generic modality schema (Generic Modalities Schema) shown in FIG. 24, thin-frame boxes indicate classes, and bold-frame boxes indicate instances. In FIG. 24, “StartButton”, “ResetButton”, “10Key-1”, . . . , “10Key-0” respectively mean physical buttons such as a start button, reset button, ten-keys, and the like of the copier, and are defined as instances of physical button class “PhysicalButton” defined in the generic modality schema (FIG. 9). The UI developer of the copier describes a UI by directly using these terms.

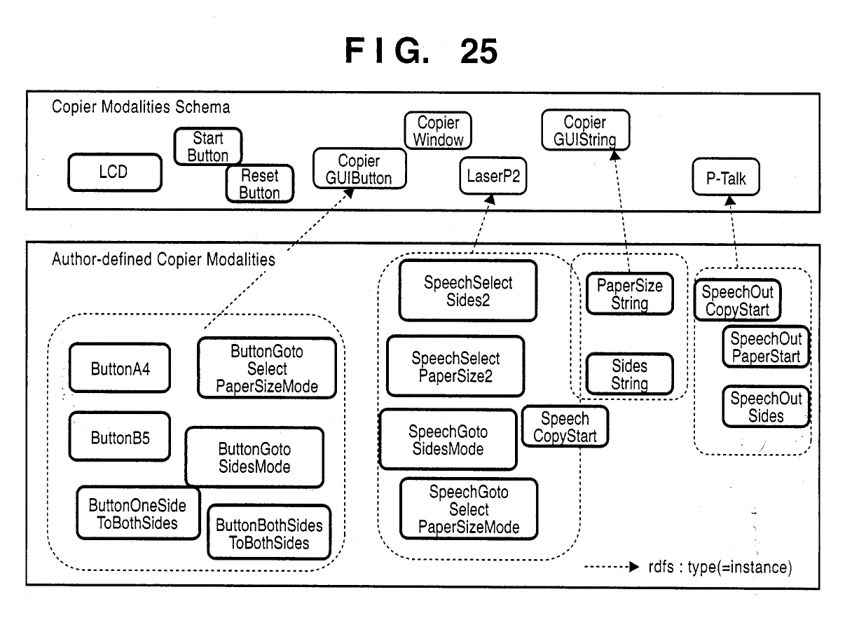

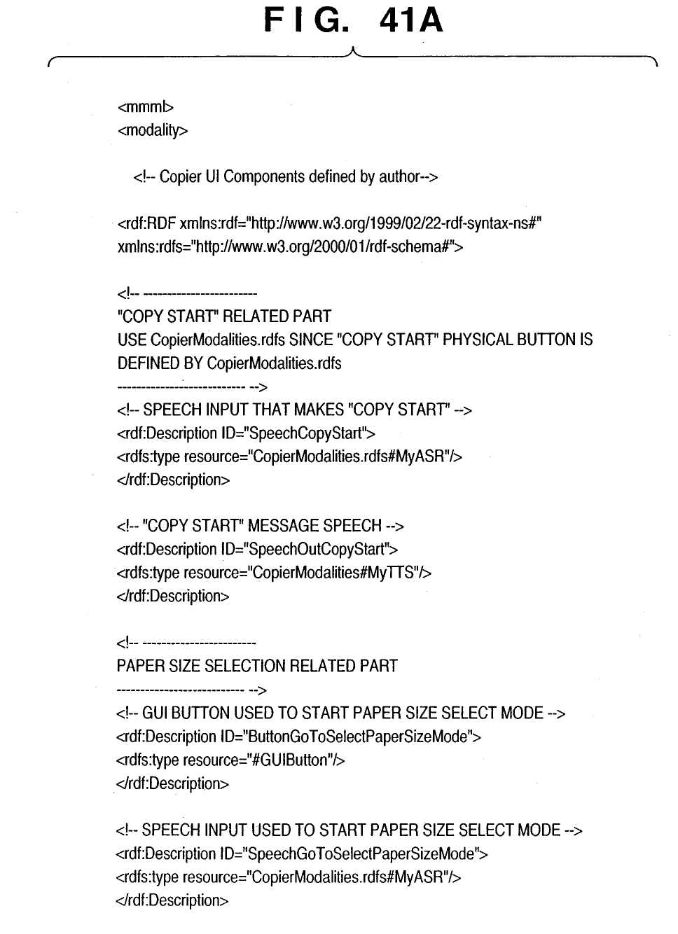

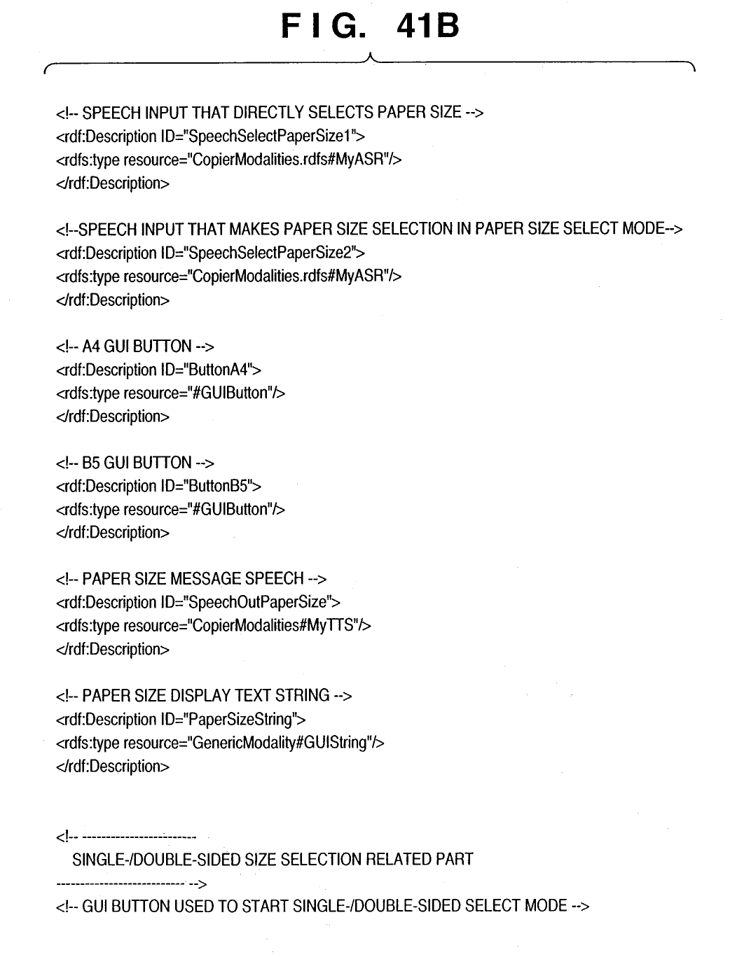

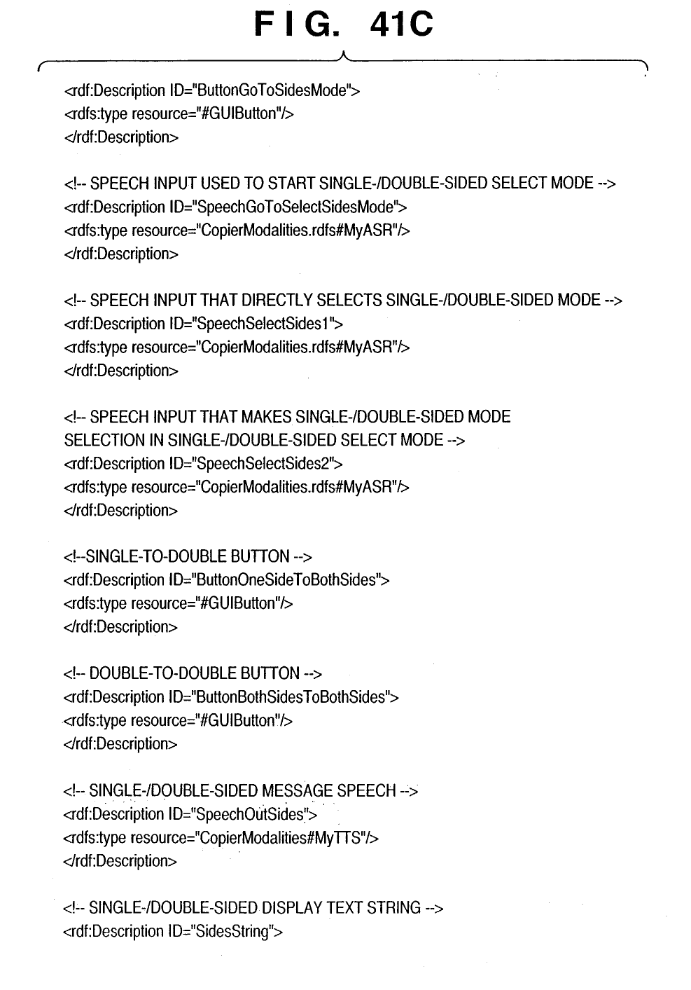

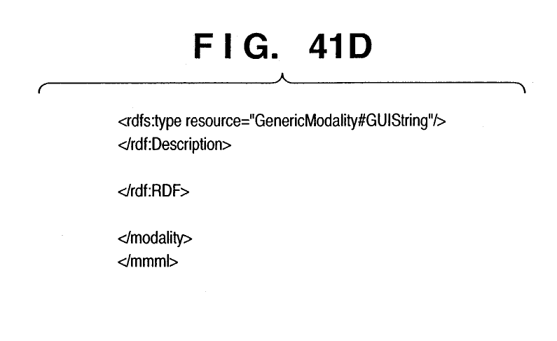

On the other hand, “CopierGUIButton” and the like are classes which represent buttons of a GUI, and are not instances. That is, these classes merely imply that “GUI buttons can be used”, and the UI developer determines GUI buttons to be practically laid out. The UI developer can freely design a GUI by defining instances of GUI buttons using such modality schema of the device provided by the device manufacturer. For example, FIG. 25 schematically expresses a new modality schema defined by the UI developer (Author-defined Copier Modalities) with respect to the copier modality schema (Copier Modalities Schema). FIGS. 41A to 41D shows an XML expression of this modality schema.

<Concept of “Target”>

In the generic modality schema, class “Target” is defined. As sub-classes of “Target”, classes “Display” which indicates a display, “Window” which indicates a GUI window, and the like are defined. “Target” serves as “location” mainly for visual UI parts such as GUI parts and the like. In an XML description of each modality, “location” of that modality can be described using “target” tags.

For example, when “paper size select mode button” is to be laid out on a default window, and “A4 button”, “B5 button”, and the like are to be laid out on “paper size select sub-window” on a GUI on the LCD of the copier, “LCD” is described in a “target” tag of “paper size select mode button”, and “CopierWindow” is described in “target” tags of “A4 button” and “B5 button”. Also, “LCD” is described in a “target” tag of “CopierWindow” itself. Actual display entrusts XSL and CSS2. The display position of each part is a relative position to “Target” designated by a “target” tag.

Upon detection of an input (user's operation) corresponding to an [input] element in given [field] of a dialog layer, the contents of [filled] tags described immediately after that input are executed. Each [field] assumes either one of two status values, i.e., active and inactive. Furthermore, each [field] can activate/deactivate itself or another [field]. By describing activate/deactivate of each [field], status transition of dialog can be controlled. Since VoiceXML is based on system-oriented dialog, the control automatically advances to the next process every time one input operation is made. That is, the control advances to active [field]s in turn.

By contrast, in this dialog description, active/inactive status of each [field] never changes unless each [field] is explicitly activated/deactivated. In order to explicitly activate/deactivate each [field], such designation is described using activate and deactivate tags in a [filled] tag. The roles of [field] and elements of [field] (tags described in a [field] tag) will be described in detail below in respective clauses.

<Role of [Field]>

Each [field] represents a minimum input/output unit (minimum dialog unit) in a UI dialog description, and describes the type of input to be accepted, and an operation to be executed or the content to be output in response to that input. The type of input is expressed by an [input] tag, and the operation to be executed in response to the input is expressed by a [filled] tag. The output is expressed by an [output] tag. Only an active [field] allows input/output. The control does not advance to the next [field] upon completion of input unlike in [field] of VoiceXML. A description “advance to next field” is implemented by an explicit description that activates the next [field] and deactivates the self [field].

<Example of Dialog Layer of Copier>

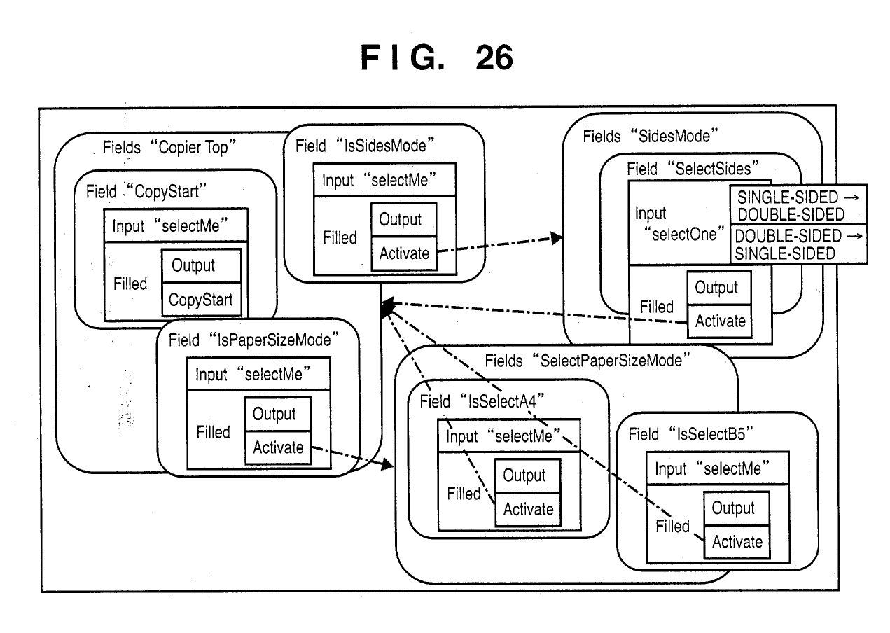

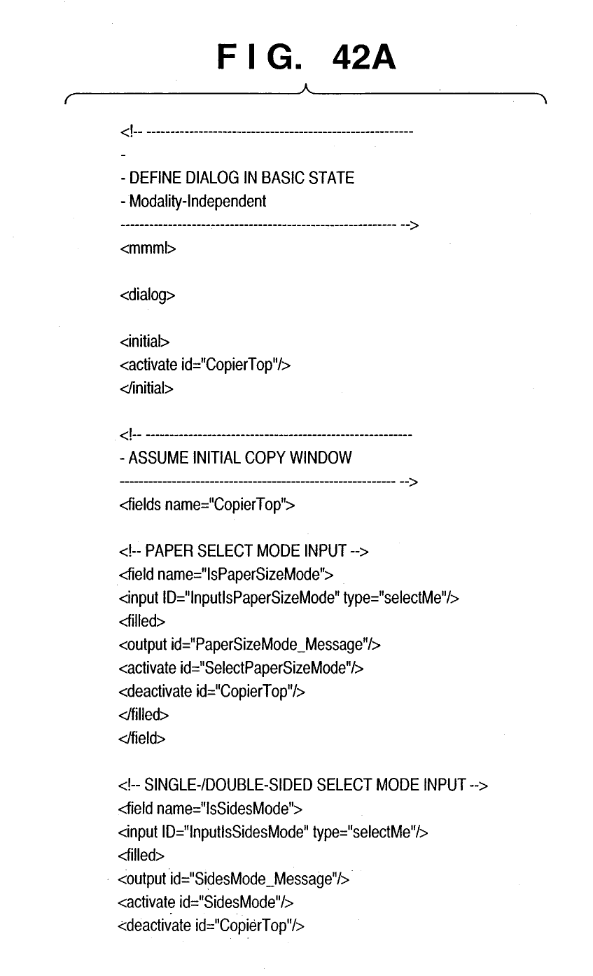

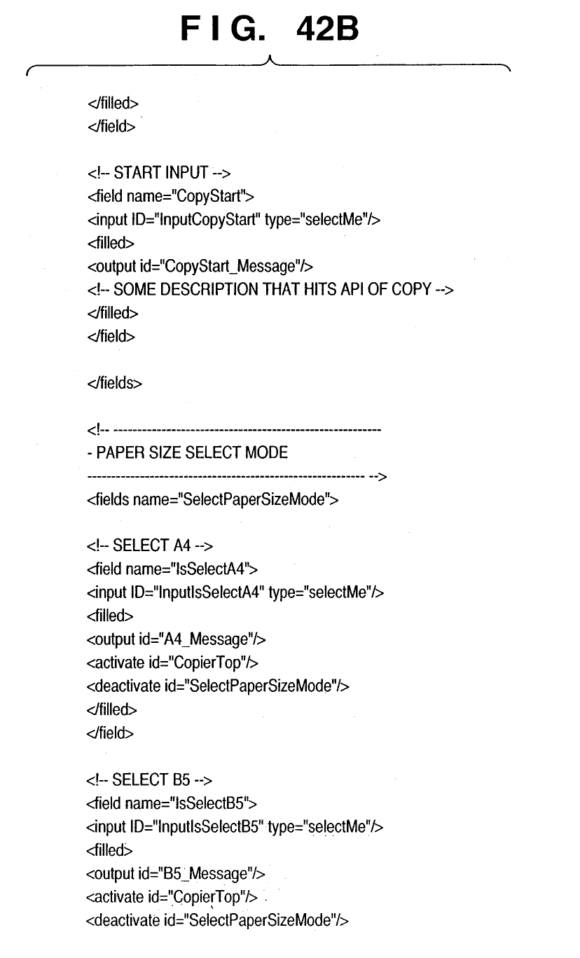

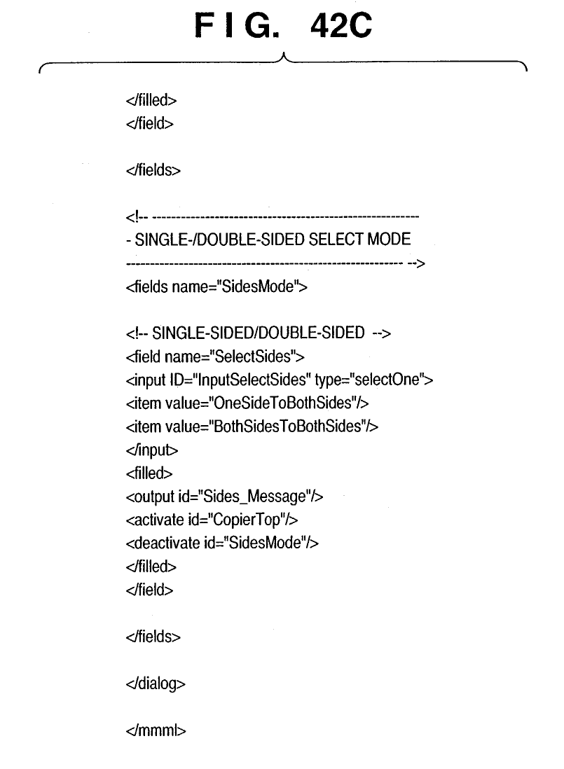

FIG. 26 shows a description example of a dialog layer of the copier UI, and FIGS. 42A to 42C show its XML description.

This example describes a UI that designates execution of copy (CopyStart), paper size (PaperSize), and single-/double-sided (PrintSides). Note that this example gives no modality description, i.e., does not describe any UI parts (button input, speech input, text. display, speech output, and the like) to be practically used (modality-independent).

<Description Example of Bind Layer of Copier UI>

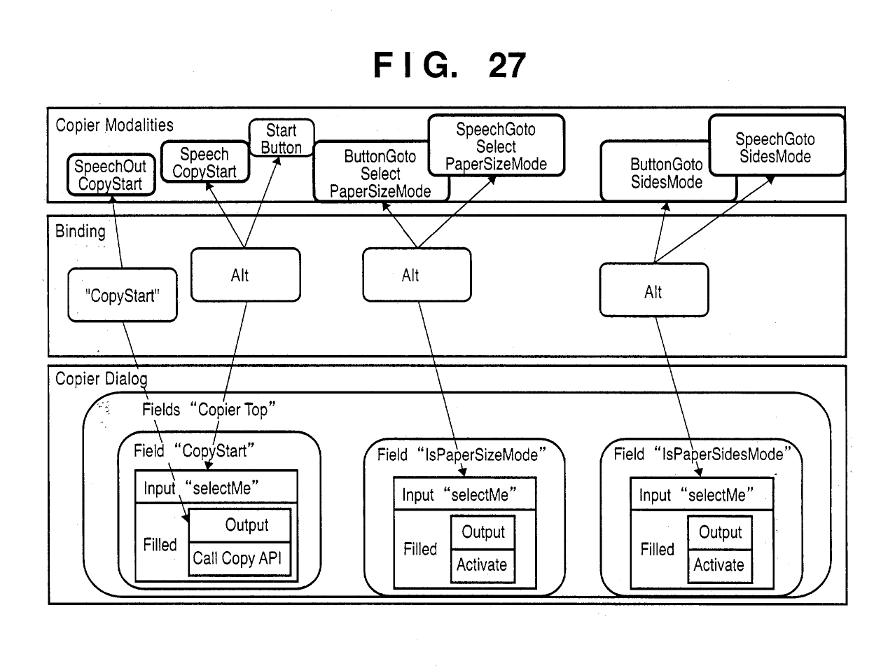

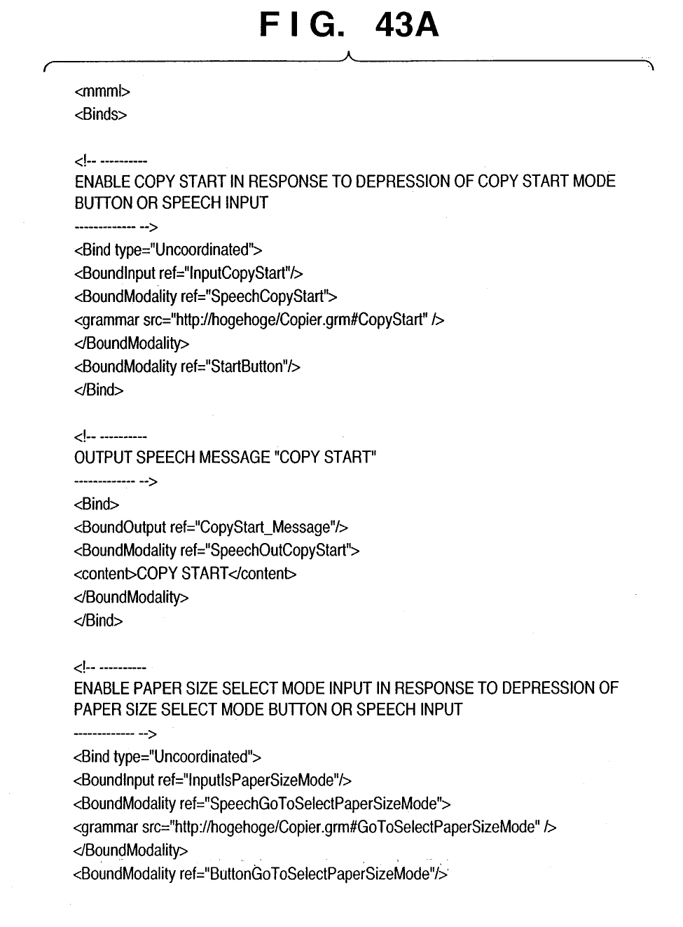

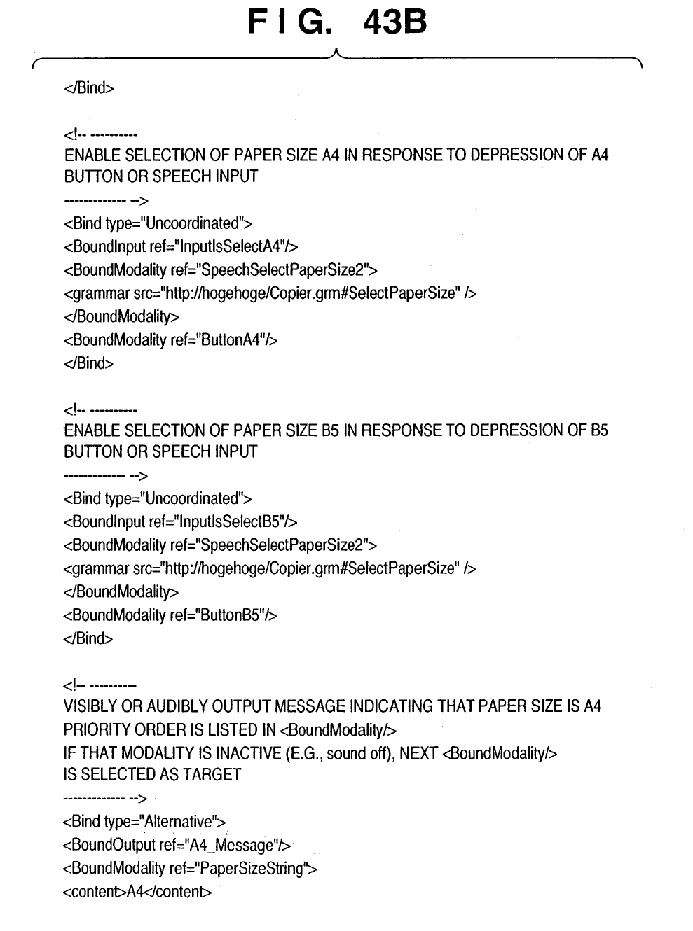

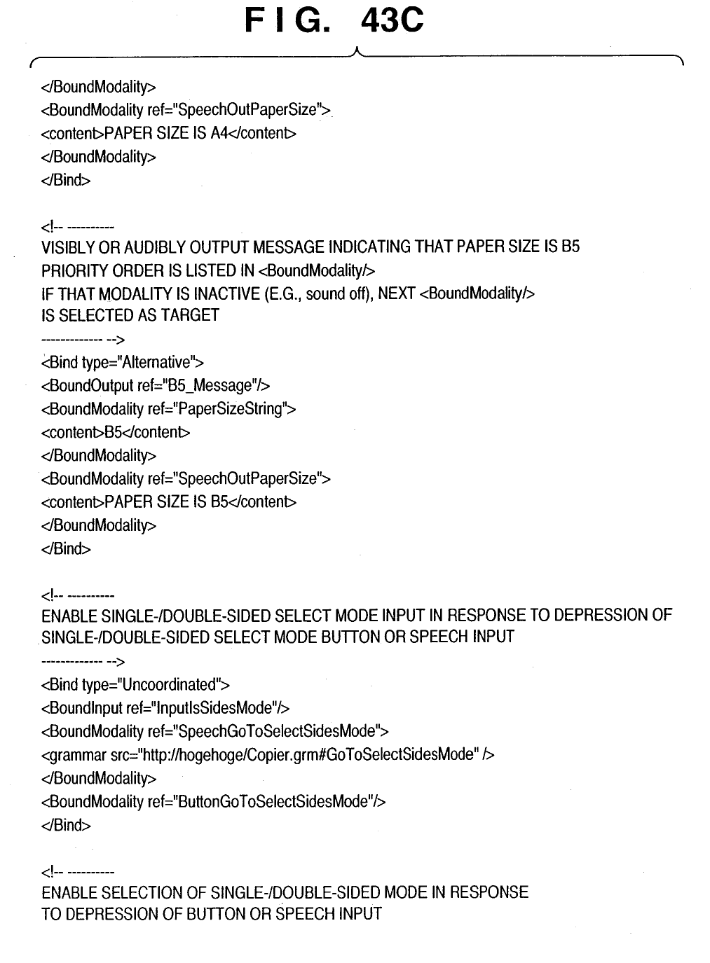

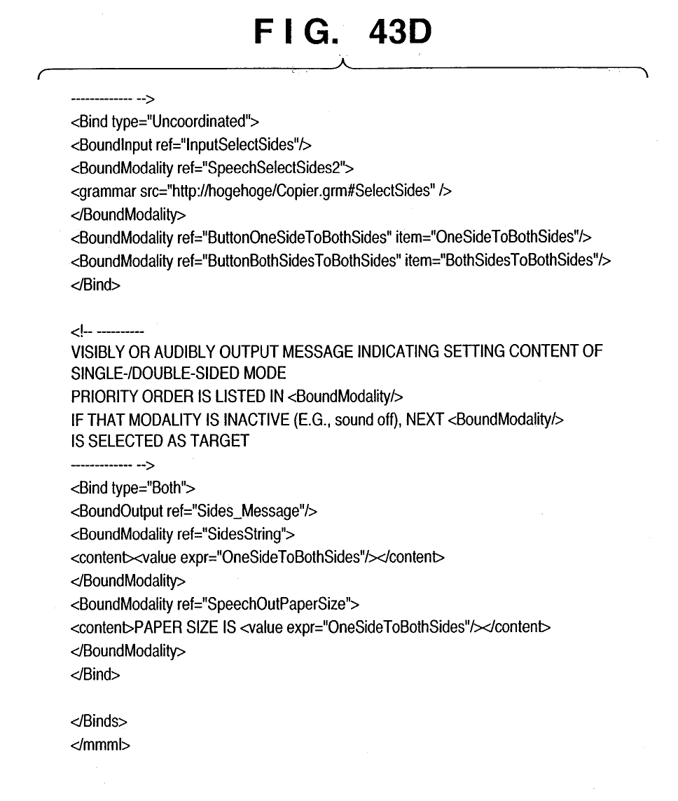

FIGS. 27 to 29 show a description example of a bind layer of the copier UI. FIGS. 43A to 43D show its XML expression.

A copier will be exemplified as a device that operates according to the markup language with such specification.

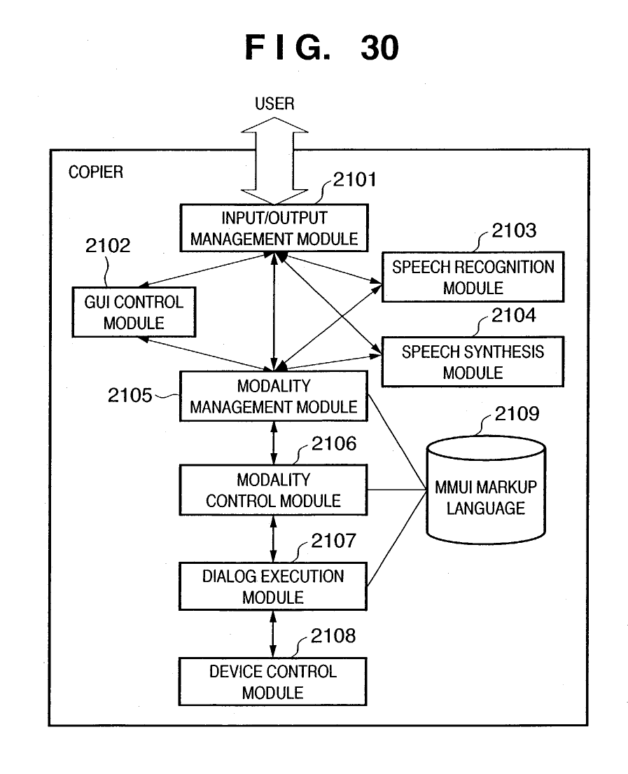

FIG. 30 is a functional block diagram of a copier according to the fifth embodiment of the present invention.

Referring to FIG. 30, reference numeral 2101 denotes an input/output management module, which manages data input/output and speech input/output. Reference numeral 2102 denotes a GUI control module, which controls a GUI in accordance with user's operations. Reference numeral 2103 denotes a speech recognition module, which recognizes input speech. Reference numeral 2104 denotes a speech synthesis module, which synthesizes speech of data to be output as speech.

Reference numeral 2105 denotes a modality management module, which runs according to the description of the modality layer of the markup language, and manages modalities (UI parts).

Reference numeral 2106 denotes a modality control module, which runs according to the description of the bind layer of the markup language. That is, the module 2106 executes control to, e.g., activate/deactivate bound modalities, a process for passing an input via a given modality to corresponding input element of the dialog layer, and a process for passing output contents to a bound modality in accordance with an output element of the dialog layer, and making output via that modality.

Reference numeral 2107 denotes a dialog execution module, which runs according to the description of the dialog layer of the markup language, and executes status transition (activate/deactivate each field) of dialog, and actions such as instructions or the like that pertain to device control. Reference numeral 2108 denotes a device control module which executes an instruction that pertains to device control from the dialog execution module 2107 when it receives such instruction (e.g., executes a copy process in accordance with an instruction “start copy”).

In this way, the modality control module 2106 executes various kinds of control of processes between the modality management module 2105 and dialog execution module 2107.

Reference numeral 2109 denotes a multi-modal user interface (MMUI) markup language.

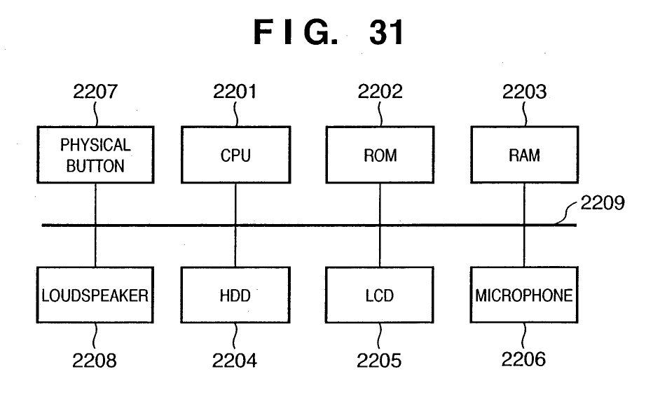

FIG. 31 is a block diagram showing the hardware arrangement of the copier according to the fifth embodiment of the present invention.

Referring to FIG. 31, reference numeral 2201 denotes a CPU which operates in accordance with a program that implements the flow chart to be described later. Reference numeral 2203 denotes a RAM, which provides a storage area, work area, and data temporary save area required to run the program. Reference numeral 2202 denotes a ROM which holds the program that implements the flow chart to be described later, and various data. Reference numeral 2204 denotes a disk device which holds MMUI markup language 2109.

Reference numeral 2205 denotes a liquid crystal display device (LCD), which displays GUI parts such as icons and the like generated by the GUI control module 2102. Reference numeral 2206 denotes a microphone used to input speech to the speech recognition module 2103. Reference numeral 2207 denotes physical buttons which include the start button, reset buttons, ten-keys, and the like shown in FIG. 23. Reference numeral 2208 denotes a loudspeaker which outputs speech synthesized by the speech synthesis module 2104. Reference numeral 2209 denotes a bus which interconnects the respective building components.

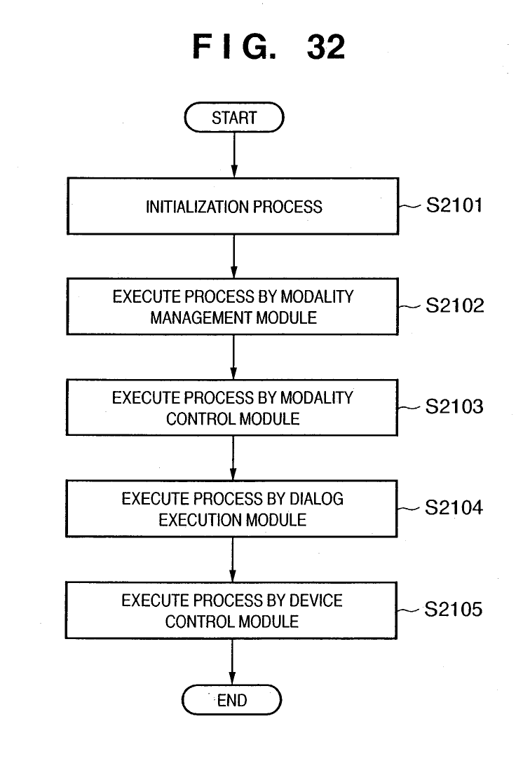

The process to be executed by the copier according to the fifth embodiment of the present invention will be described below with reference to FIG. 32.

FIG. 32 is a flow chart for explaining the process to be executed by the copier according to the fifth embodiment of the present invention.

In step S2101, the dialog execution module 2107 executes an initialization process of a device with reference to the MMUI markup language 2109.

In step S2102, the modality management module 2105 executes processes such as status management of various modalities described in the modality layer, and the like on the basis of an input from the input/output management module 2101/modality control module 2106, with reference to the modality layer in the MMUI markup language 2109.

In step S2103, the modality control module 2106 executes processes such as exchange of information between modalities and corresponding input/output elements, activate/deactivate of modalities, and the like on the basis of an input form the modality management module 2105/dialog execution module 2107 with reference to the bind layer in the MMUI markup language 2109.

In step S2104, the dialog execution module 2107 executes processes such as acceptance of input from each modality, an instruction of output to each modality, acceptance of an event, status transition of dialog, an action to be taken in response to each input or event, and the like on the basis of an input from the modality control module 2106/device control module 2108 with reference to the dialog layer in the MMUI markup language 2109.

In step S2105, the device control module 2108 executes device control on the basis of an input from dialog execution module 2107.

Note that the processes in steps S2101 to S2105 in FIG. 22 have especially exemplified a case wherein the device control module 2108 executes an arbitrary process in accordance with an input from the input/output management module 2101. However, processes may be executed in the order opposite to the above processes, i.e., processes from step S2105 to S2101 may be executed, the step order may be replaced in coordination of respective steps, or some steps may be omitted depending on the processing contents of the respective steps.

A practical operation example of the copier shown in FIG. 30 will be described below. An operation example according to the markup language which has FIG. 25 as the modality layer (FIGS. 41A to 41D), FIG. 26 as the dialog layer (FIGS. 42A to 42C), and FIGS. 27 to 29 as the bind layer (FIGS. 43A to 43D) will be explained.

The dialog execution module 2107 executes an initialization process described between tags <initial> and </initial> in FIGS. 42A to 42C with reference to the MMUI markup language 2109. In this case, the dialog execution module 2107 activates only “CopierTop” fields. That is, only [field]s included in “CopierTop” fields are activated, i.e., are allowed to input/output, and other [field]s are precluded from interaction targets.

Accordingly, the modality control module 2106 activates only modalities bound to input/output elements in [field]s included in “CopierTop” fields, and deactivates other modalities.

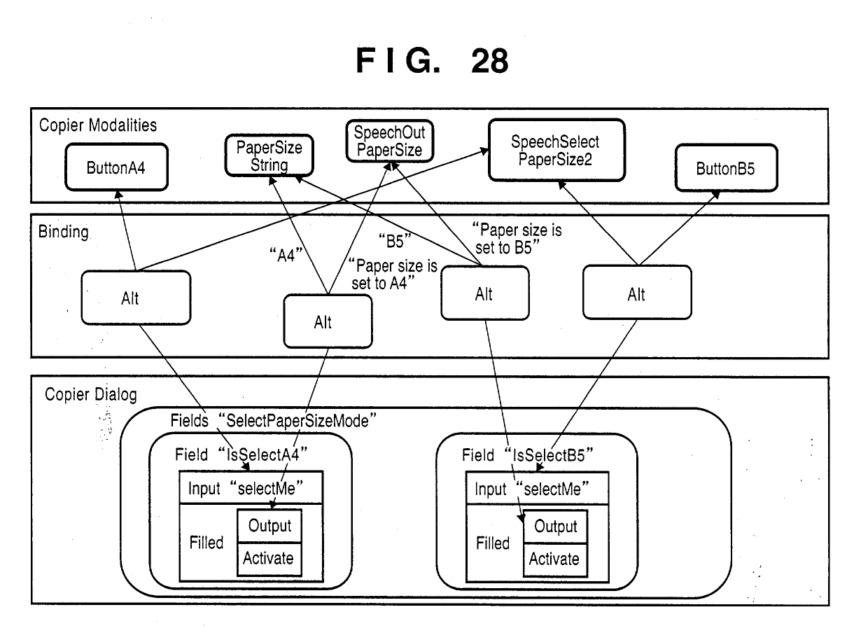

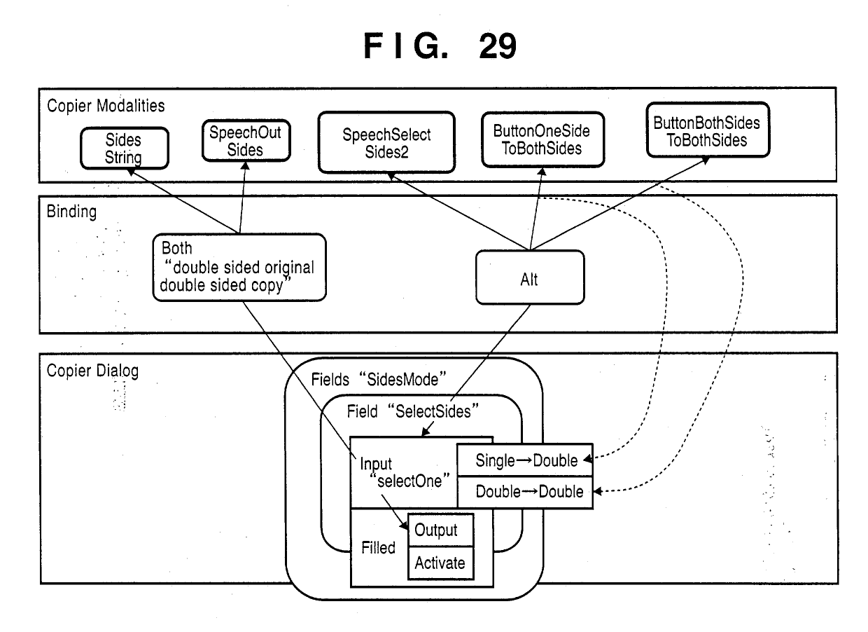

That is, only modalities shown in FIG. 27 are activated, and corresponding speech input/output, and depression of corresponding GUI buttons are enabled. On the other hand, modalities shown in FIGS. 28 and 29 are inactive, and depression of corresponding GUI buttons is disabled.

Note that the depression enabled and disabled states of each GUI button are displayed in different display patterns that can identify the corresponding states (e.g., the depression disabled state is indicated by graying out or flickering a corresponding button) on a GUI. In FIG. 27, a start button and speech input modality are bound to an input element of “CopyStart” field of the dialog layer in a selective use mode.

Therefore, if the start button is pressed or corresponding speech input is made, this input element accepts the input, and the dialog execution module 2107 executes a process described in a corresponding [filled] element.

In the example of FIG. 27, after an [output] element executes an arbitrary output, a copy execution instruction is issued to the device control module 2108. Note that the [output] element itself does not describe any contents to be output, and a bind element describes “start copy”. Since this [output] element is bound to a speech synthesis modality, synthetic speech “start copy” is produced. Also, since this [filled] element does not describe about activate/deactivate of [field], status change (active/inactive) of each [field] does not take place, and only [field]s and modalities shown in FIG. 27 remain active.

In FIG. 27, a GUI button and speech input modality which are used to select a paper size select mode are bound to an input element of “IsPaperSizeMode” field of the dialog layer in a selective use mode. Hence, if this GUI button is pressed or corresponding speech input is made, this input element accepts the input, and the dialog execution module 2107 executes a process described in a corresponding [filled] element. Since this [filled] element describes to activate “SelectPaperSizeMode” fields, [field]s in this [fields] are made active.

Accordingly, the modality control module 2106 activates modalities bounded to input/output elements of these [field]s, i.e., modalities shown in FIG. 28, for example, depression of GUI button “ButtonA4” is enabled.

With the above sequence, a multi-modal user interface according to the markup language is implemented.

As described above, according to the fifth embodiment, in an environment in which processes associated with a device are implemented based on a markup language, this markup language especially includes,

a dialog description of the device,

a modality description of the device, and

a bind description that binds these dialog and modality descriptions.

The device comprises a modality management module which makes input/output management using respective modalities in accordance with the contents of the modality description in the markup language, a modality control module which exchanges information between respective modalities and input/output elements bounded to them in accordance with the description of the bind layer of the markup language, and a dialog execution module which accepts inputs from respective modalities managed by the modality management module, and executes instructions of outputs to respective modalities in accordance with the contents of the dialog description in the markup language.

In this way, since an effective combination of various modalities of the device can be described using the markup language, a multi-modal user interface with higher usability can be implemented.

[Sixth Embodiment]

The fifth embodiment has exemplified a case wherein the copier is operated via modalities of the copier itself. However, a PC, mobile phone, or the like independent from the copier may be used as a control device of a device to be controlled. In the sixth embodiment, the edit method of a markup language for operating the copier from the mobile phone, and its operation will be explained.

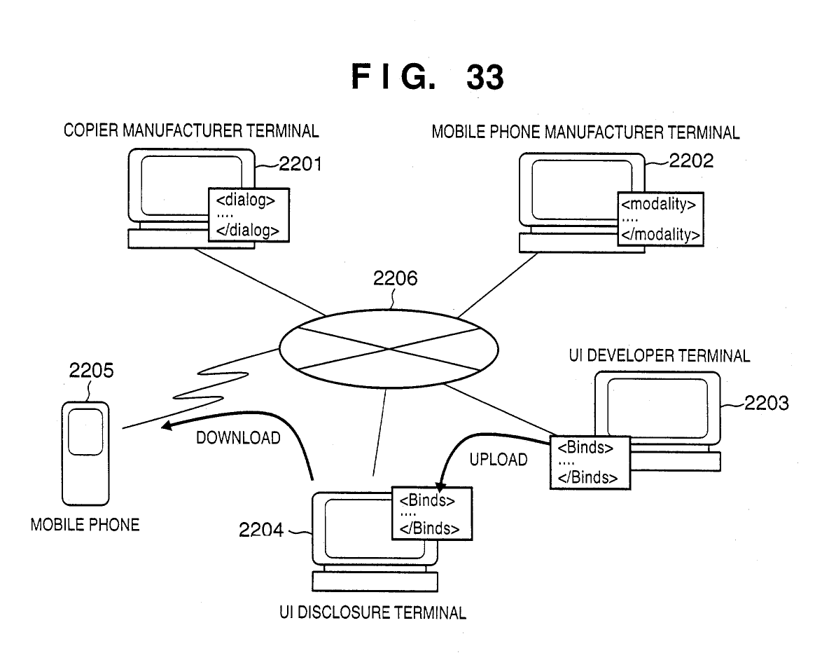

The edit method of the markup language will be explained below with reference to FIG. 33.

FIG. 33 is a diagram showing the arrangement of an information processing system according to the sixth embodiment of the present invention.

The copier itself has already been installed with a markup language with the configuration described using FIGS. 25 to 29, and can be operated via its own modalities. Correspondence among inputs, operations to be executed by the copier, outputs of the copier, and transition of dialog states is determined by the functions of the copier itself, and the copier operates according to the description of the dialog layer in FIG. 26.

A markup language which allows another device to operate this copier is developed by describing a modality layer of that control device itself, and a bind layer which binds this modality layer, and the dialog layer of the copier itself. To allow such development, the manufacturer of the copier discloses the dialog layer of the copier on, e.g., a Web site provided on a copier manufacturer terminal 2201 of that manufacturer.

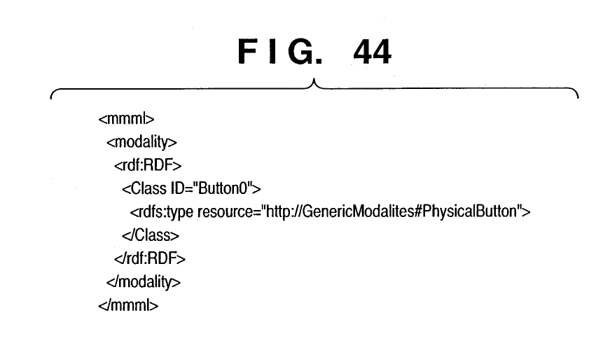

On the other hand, since the modality layer of a mobile phone used as the control device is unique to that mobile phone, it is natural to describe the modality layer by a mobile phone device manufacturer. The mobile phone device manufacturer discloses the modality layer of the mobile phone on, e.g., a Web site provided on a mobile phone manufacturer terminal 2202 of that manufacturer. FIG. 44 shows a description example of a markup language of the modality layer of the mobile phone. In this example, a “0” button (Button0) is defined.

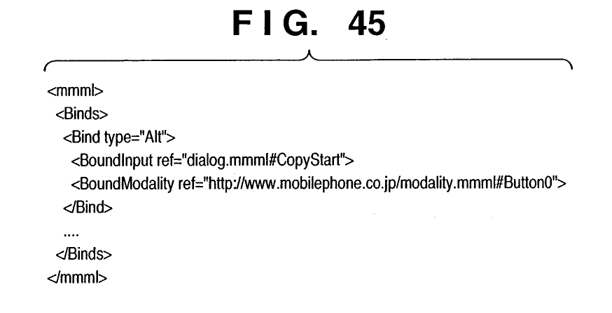

A UI developer who develops a markup language which describes an MMUI that allows this mobile phone to operate the copier describes a bind layer that binds the modality layer of the mobile phone and the dialog layer of the copier with reference to the disclosed modality and dialog layers. FIG. 45 shows a description example of a markup language of this bind layer. In this example, the “0” button of the mobile phone is bound to a “copy start” input element.

The UI developer discloses the developed markup language (bind layer) on a Web site provided on his or her own UI developer terminal 2204.

The user downloads the disclosed markup language (bind layer) to his or her mobile phone 2205.

In this manner, the markup language of the present invention is not described by the UI developer alone, but allows division of labor such that a modality layer is developed by the manufacturer of a control device, a dialog layer is developed by the manufacturer of a device to be controlled, and the UI developer who wants to bind these layers describes a bind layer.

This merit is provided since the markup language of the present invention has the aforementioned three-layered structure. With this structure, a markup language not only for a combination of the mobile phone and copier but also combinations of other arbitrary devices, which serve as a control device and device to be controlled, can be easily developed. For example, when a bind layer which binds a modality layer of a mobile phone, and a dialog layer of an air-conditioner disclosed by an air-conditioner manufacturer is developed, the user can operate the air-conditioner from the mobile phone.

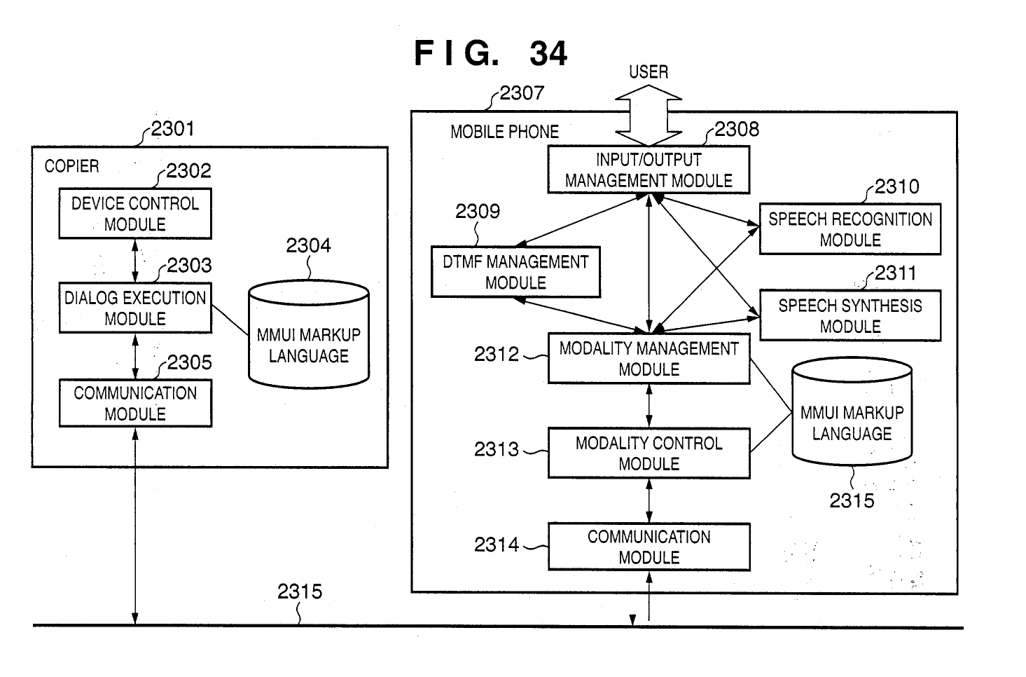

The operation of the copier and mobile phone in the sixth embodiment will be explained below with reference to FIG. 34. Since the operations of respective building components in FIG. 34 are basically the same as those of the building components in FIG. 30 explained in the fifth embodiment, interactions between the copier and mobile phone will be explained.

Note that a device control module 2302 and dialog execution module 2303 of a copier 2301 in FIG. 34 respectively correspond to the device control module 2108 and dialog execution module 2107 in FIG. 30. Also, an input/output management module 2308, speech recognition module 2310, speech synthesis module 2311, modality management module 2312, and modality control module 2313 of a mobile phone 2307 respectively correspond to the input/output management module 2101, speech recognition module 2103, speech synthesis module 2104, modality management module 2105, and modality control module 2106 in FIG. 30. Furthermore, MMUI markup languages 2306 and 2315 in FIG. 14 correspond to the MMUI markup language 2109 in FIG. 30. In addition, a DTMF management module 2309 makes DTMF management of the mobile phone 2307. Communication modules 2305 and 2314 communicate with each other via a network 2315.

The mobile phone 2307 transmits an operation request to the copier 2301 via the communication module 2314, thus starting dialog between the mobile phone 2307 and copier 2301. The dialog execution module 2303 of the copier 2301 operates according to the description of the dialog layer. The dialog execution module 2303 transmits information indicating the current active [field], and the ID of an output element if an output operation is instructed, in each step described in the dialog layer, to the mobile phone 2307 via the communication module 2305.

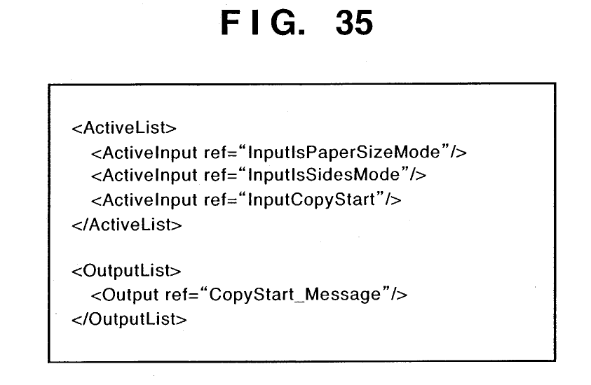

FIG. 35 shows an example of this transmitted information. This example indicates that input elements listed between <ActiveList> and </ActiveList> are currently active, and an output corresponding to an output element “CopyStart_Message” is to be made.

The mobile phone 2307 receives this transmitted information via the communication module 2314. The modality control module 2313 makes an output via a modality bound to “CopyStart_Message” on the basis of the received information, and the output from the MMUI markup language 2315 (for example, a synthetic speech message “start copy” is output). Also, the module 2313 activates modalities bounded to the input elements listed between <ActiveList> and </ActiveList>, and deactivates other modalities. Furthermore, when the user has made an input to the mobile phone 2307, the mobile phone 2307 transmits the ID of an input element bound to that modality, and the input contents to the copier 2301.

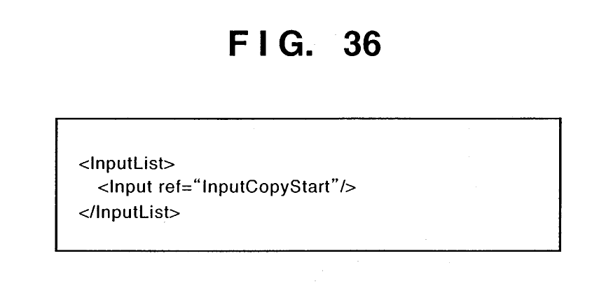

FIG. 36 shows an example of this transmitted information. This example means information of an input that has been made to an input element listed between <InputList> and </InputList> to the copier 2301. In this way, the copier can be operated using the mobile phone 2307 as a control device.

As described above, according to the sixth embodiment, in an environment in which processes associated with a control device and a device to be controlled are implemented based on a markup language, this markup language especially includes,

a dialog description of the device to be controlled,

a modality description of the control device, and

a bind description that binds these dialog and modality descriptions.

The control device comprises a modality management module that makes input/output management using respective modalities in accordance with the contents of the modality description in the markup language, and a modality control module that exchanges information between respective modalities and input/output elements bound to them in accordance with the description of a bind layer in the markup language. The device to be controlled comprises a dialog execution module that accepts inputs from respective modalities managed by the modality management module, and executes instructions of outputs to respective modalities in accordance with the contents of the dialog description in the markup language.

In this manner, arbitrary devices (e.g., a PDA, remote controller, and the like) can serve as control devices to control other arbitrary devices (OA devices such as a facsimile, printer, scanner, and the like, home electric appliances such as an electric pot, refrigerator, television, and the like) as devices to be controlled. Also, such control device can comprise a multi-modal user interface.

[Seventh Embodiment]

The sixth embodiment has exemplified a case wherein when a control device (mobile phone) is independent from a device to be controlled (copier), only the device to be controlled has the dialog layer. The seventh embodiment will exemplify a case wherein a dialog layer unique to the control device can be described in the control device independently of that of the device to be controlled.

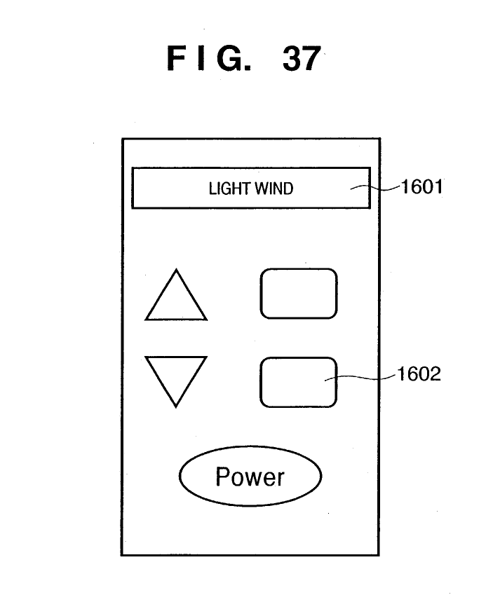

For example, a case will be examined below wherein a UI that controls an air-conditioner from a remote controller shown in FIG. 37 is described in a markup language. Assume that a [field] that selects a wind strength from “light wind”, “normal wind”, and “strong wind” is defined in the dialog layer of the air-conditioner, and an appropriate modality is to be bound to an input element (“selectOne” type) of this [field].

When the control device comprises a sufficiently large number of kinds of GUI parts, for example, a radio button or pull-down menu can be bound to this input element. However, when a button A 1602 of the remote controller is to be bound, only a description that switches the wind strength by repetitively pressing the button A 1602 can be given. However, since the meaning of depression of the button, i.e., the corresponding wind strength, changes every time the button is pressed, simple binding cannot be made.

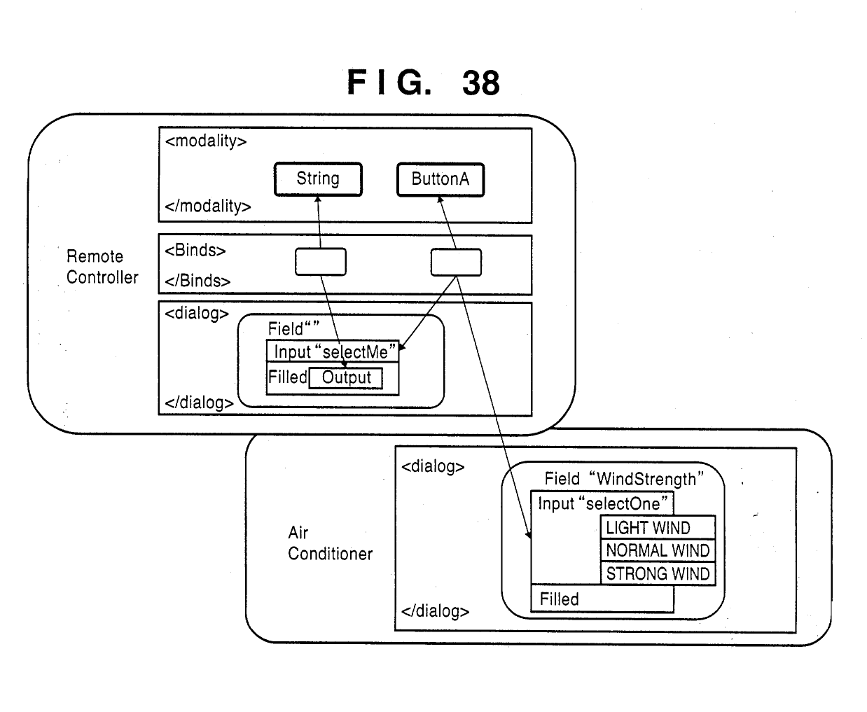

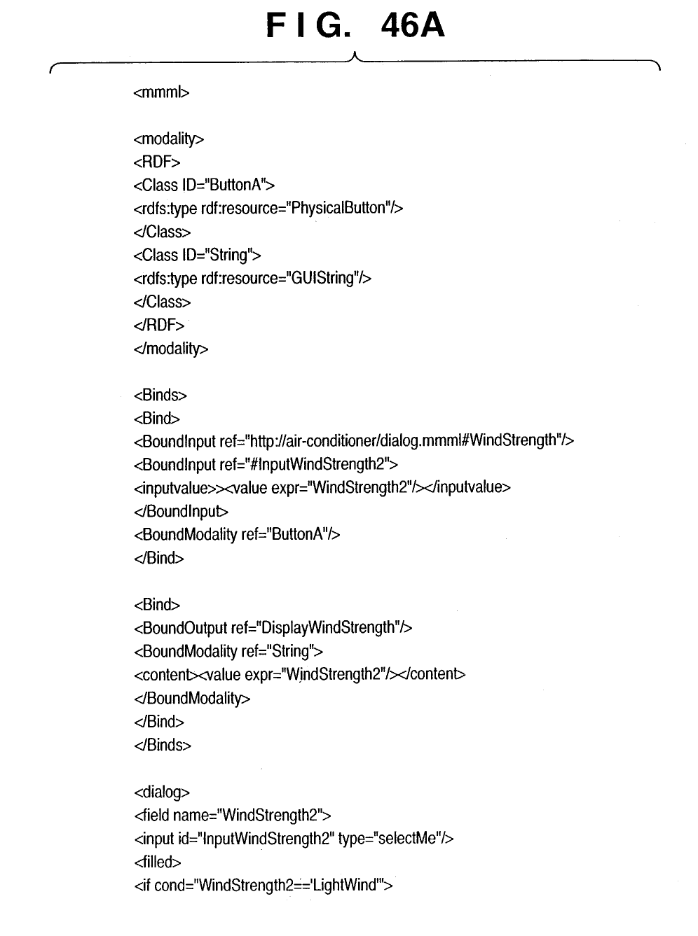

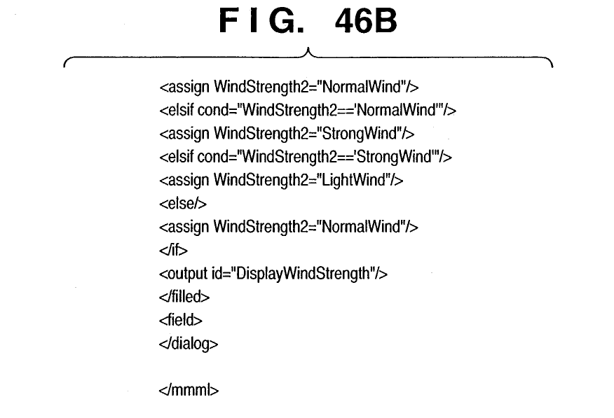

In such case, the markup language of the present invention can describe a dialog layer unique to a control device (remote controller in the seventh embodiment) in addition to that of a device to be controlled (air-conditioner in the seventh embodiment). FIG. 38 schematically expresses a bind description to the remote controller dialog layer unique to the remote controller, and the air-conditioner dialog layer in this example. In this example, a modality, i.e., the button A 1602, is bound to a wind strength setting input element of the air-conditioner dialog layer and also to an input element of the dialog layer unique to the remote controller. Since a description that switches an input value is given in a [filled] element of a [field] having the latter input element, the value to be input to the wind strength setting input element of the air-conditioner dialog layer can be switched every time button A is pressed. FIGS. 46A and 46B show an XML expression of the description shown in FIG. 38.

[Eighth Embodiment]

In the above embodiment, only user's operations (inputs/outputs) are handled. However, in consideration of device control, event processes are also important factors. The markup language of the present invention can describe information (event information) that pertains to events such as acceptance of events, event processes, the types of events, and the like, and its embodiment will be explained below. Acceptance of an event is described using a [catch] tag inside [field] tags of the dialog layer.

<field name=“CopyCompleteEvent”>

<catch id=“CopyComplete”/>

<filled>

<output><content>Copy is

finished.</content></output>

</filled>

<field>

Assume that an event name “CopyComplete” in the above example is defined in advance in accordance with a device, and an MMML browser knows such word.

Events must be separately considered as those which pertain to a control device (client) and those which pertain to a device to be controlled (server). For example, a case will be examined below wherein a copier is controlled using a PC via a network. In this case, a “copy complete” event is that which pertains to the copier as the device to be controlled, and must be described in the dialog layer of the copier.

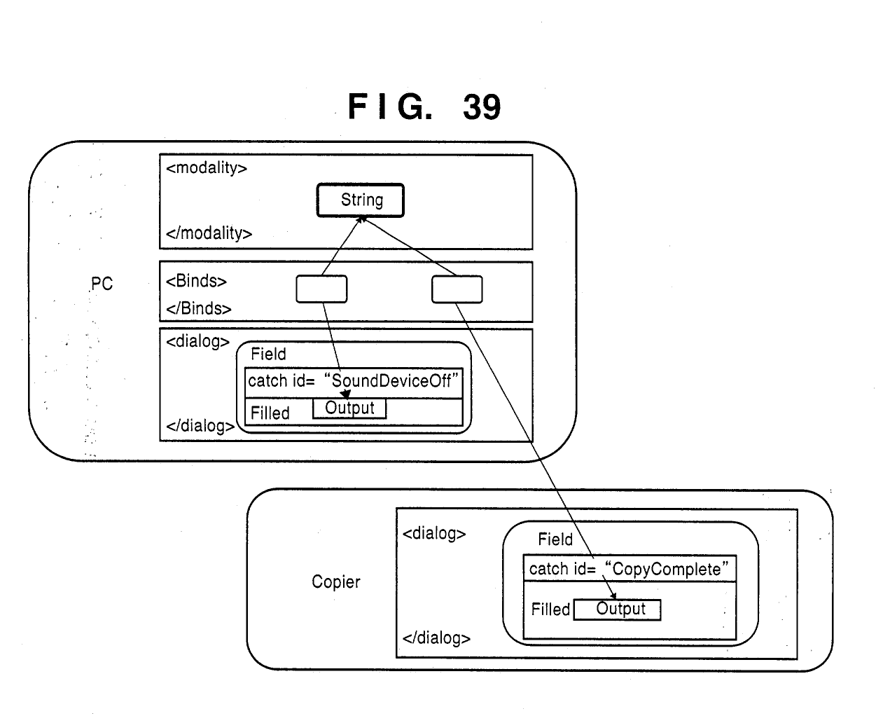

On the other hand, a “sound device is OFF” event of the PC is that which is closed within the PC as the control device, and is free from the dialog layer of the copier. In such case, a description of the event which is closed within the PC can be given by forming a dialog layer unique to the PC independently of that of the copier, and defining a [field] which catches the event in that layer. FIG. 39 shows a description example which includes event information.

[Ninth Embodiment]

In the first to eighth embodiments, the program which implements the operation to be executed by each device is held in the ROM. However, the present invention is not limited to this, and the operation may be implemented using an arbitrary storage medium. Also, the operation may be implemented using a circuit that implements a similar operation.

The embodiments have been explained in detail, but the present invention may be applied to a system constituted by a plurality of devices or an apparatus consisting of a single device.

Note that the present invention includes a case wherein the invention is achieved by directly or remotely supplying a program of software that implements the functions of the aforementioned embodiments (a program corresponding to the flow charts shown in the respective drawings in the embodiments) to a system or apparatus, and reading out and executing the supplied program code by a computer of that system or apparatus. In this case, software need not have the form of program as long as it has the program function.

Therefore, the program code itself installed in a computer to implement the functional process of the present invention using the computer implements the present invention. That is, the present invention includes the computer program itself for implementing the functional process of the present invention.

In this case, the form of program is not particularly limited, and an object code, a program to be executed by an interpreter, script data to be supplied to an OS, and the like may be used as along as they have the program function.

As a recording medium for supplying the program, for example, a floppy disk, hard disk, optical disk, magnetooptical disk, MO, CD-ROM, CD-R, CD-RW, magnetic tape, nonvolatile memory card, DVD (DVD-ROM, DVD-R)), and the like may be used.

As another program supply method, the program may be supplied by establishing connection to a home page on the Internet using a browser on a client computer, and downloading the computer program itself of the present invention or a compressed file containing an automatic installation function from the home page onto a recording medium such as a hard disk or the like. Also, the program code that forms the program of the present invention may be segmented into a plurality of files, which may be downloaded from different home pages. That is, the present invention includes a WWW server which makes a plurality of users download a program file required to implement the functional process of the present invention by the computer.

Also, a storage medium such as a CD-ROM or the like, which stores the encrypted program of the present invention, may be delivered to the user, the user who has cleared a predetermined condition may be allowed to download key information that decrypts the program from a home page via the Internet, and the encrypted program may be executed using that key information to be installed on a computer, thus implementing the present invention.

The functions of the aforementioned embodiments may be implemented not only by executing the readout program code by the computer but also by some or all of actual processing operations executed by an OS or the like running on the computer on the basis of an instruction of that program.

Furthermore, the functions of the aforementioned embodiments may be implemented by some or all of actual processes executed by a CPU or the like arranged in a function extension board or a function extension unit, which is inserted in or connected to the computer, after the program read out from the recording medium is written in a memory of the extension board or unit.

The present invention is not limited to the above embodiments and various changes and modifications can be made within the spirit and scope of the present invention. Therefore, to appraise the public of the scope of the present invention, the following claims are made.

What is claimed is:

1. An information processing apparatus which supports control between a control device and a device to be controlled via a network, comprising:
first reception means for receiving modality information associated with modalities of the control device;
second reception means for receiving dialog information associated with dialog of the device to be controlled;
generation means for generating bind information that infers a relationship between the modality information and the dialog information, and binds the modality information and the dialog information; and
transmission means for transmitting the bind information and the dialog information to the control device.

2. The apparatus according to claim 1, wherein the modality information, dialog information, and bind information are described in a markup language, and
the markup language includes
a dialog description indicating contents of the dialog of the device to be controlled,
a modality description which is formed independently of the dialog description, and indicates the modalities of the control device, and
a bind description that binds the modality description and the dialog description.

3. The apparatus according to claim 2, wherein the dialog description is formed of one or a plurality of minimum dialog units which serve as input/output processing units, and each minimum dialog unit includes zero or one input element, and zero, or one or more output elements.

4. The apparatus according to claim 2, wherein the modality description includes a hierarchical relationship among modality classes, and instances of the modalities, and a modality of the control device is defined as a sub-class and instance of a generic modality defined in a generic modality description that describes definitions of generic modalities with reference to the generic modality description.

5. The apparatus according to claim 2, wherein the bind description is a description which binds one or a plurality of modalities to one or a plurality of input elements, and includes a description of a method of combining modalities when a plurality of modalities are to be bound to one input element.

6. The apparatus according to claim 2, wherein the bind description is a description which binds one or a plurality of modalities to one or a plurality of output elements, and includes a description of a method of combining modalities when a plurality of modalities are to be bound to one output element.

7. The apparatus according to claim 2, wherein the control device comprises:
management means for managing the modalities in accordance with the modality description; and
modality control means for controlling processes between the modalities and dialog in accordance with the bind description, and
the device to be controlled comprises:
dialog execution means for managing the dialog in accordance with the dialog description; and
control means for executing control of the device to be controlled on the basis of an instruction from said dialog execution means.

8. The apparatus according to claim 4, further comprising storage means for storing a bind sample which describes the generic modalities, input/output elements which can be bound to the generic modalities, and appropriate level information of binding, and
wherein said generation means generates the bind information that infers a relationship between the modality information and the dialog information, and binds the modality information and the dialog information, with reference to the bind sample.

9. An information processing apparatus which serves as a control device that controls an operation of a device to be controlled, comprising:
reception means for receiving dialog information associated with dialog of the device to be controlled;
generation means for generating bind information that infers a relationship between modality information associated with modalities of said information processing apparatus, and the dialog information, and binds the modality information and the dialog information;
management means for managing the modalities in accordance with the modality information; and
modality control means for controlling processes between the modality and the dialog in accordance with the bind information.

10. An information processing apparatus which serves as a device to be controlled that executes a process on the basis of an instruction from a control device, comprising:
transmission means for transmitting dialog information associated with dialog of said information processing apparatus to the control device;
dialog execution means for managing the dialog in accordance with the dialog information; and
control means for executing control of said information processing apparatus on the basis of an instruction from said dialog execution means.

11. A method of controlling an information processing apparatus which supports control between a control device and a device to be controlled via a network, comprising:
a first reception step of receiving modality information associated with modalities of the control device;
a second reception step of receiving dialog information associated with dialog of the device to be controlled;
a generation step of generating bind information that infers a relationship between the modality information and the dialog information, and binds the modality information and the dialog information; and
a transmission step of transmitting the bind information and the dialog information to the control device.

12. The method according to claim 11, wherein the modality information, dialog information, and bind information are described in a markup language, and
the markup language includes
a dialog description indicating contents of the dialog of the device to be controlled,
a modality description which is formed independently of the dialog description, and indicates the modalities of the control device, and
a bind description that binds the modality description and the dialog description.

13. The method according to claim 12, wherein the dialog description is formed of one or a plurality of minimum dialog units which serve as input/output processing units, and each minimum dialog unit includes zero or one input element, and zero, or one or more output elements.

14. The method according to claim 12, wherein the modality description includes a hierarchical relationship among modality classes, and instances of the modalities, and a modality of the control device is defined as a sub-class and instance of a generic modality defined in a generic modality description that describes definitions of generic modalities with reference to the generic modality description.

15. The method according to claim 12, wherein the bind description is a description which binds one or a plurality of modalities to one or a plurality of input elements, and includes a description of a method of combining modalities when a plurality of modalities are to be bound to one input element.

16. The method according to claim 12, wherein the bind description is a description which binds one or a plurality of modalities to one or a plurality of output elements, and includes a description of a method of combining modalities when a plurality of modalities are to be bound to one output element.

17. The method according to claim 12, wherein the control device comprises:
a management step of managing the modalities in accordance with the modality description; and
a modality control step of controlling processes between the modalities and dialog in accordance with the bind description, and
the device to be controlled comprises:
a dialog execution step of managing the dialog in accordance with the dialog description; and
a control step of executing control of the device to be controlled on the basis of an instruction from the dialog execution step.

18. The method according to claim 14, further comprising the storage step of storing, in a storage medium, a bind sample which describes the generic modalities, input/output elements which can be bound to the generic modalities, and appropriate level information of binding, and
wherein the generation step includes the step of generating the bind information that infers a relationship between the modality information and the dialog information, and binds the modality information and the dialog information, with reference to the bind sample.

19. A method of controlling an information processing apparatus which serves as a control device that controls an operation of a device to be controlled, comprising:
a reception step of receiving dialog information associated with dialog of the device to be controlled;
a generation step of generating bind information that infers a relationship between modality information associated with modalities of the information processing apparatus, and the dialog information, and binds the modality information and the dialog information;
a management step of managing the modalities in accordance with the modality information; and
a modality control step of controlling processes between the modality and the dialog in accordance with the bind information.

20. A method of controlling an information processing apparatus which serves as a device to be controlled that executes a process on the basis of an instruction from a control device, comprising:
a transmission step of transmitting dialog information associated with dialog of the information processing apparatus to the control device;
a dialog execution step of managing the dialog in accordance with the dialog information; and
a control step of executing control of the information processing apparatus on the basis of an instruction from said dialog execution means.

21. A program for making a computer control an information processing apparatus which supports control between a control device and a device to be controlled via a network, comprising:
a program code of a first reception step of receiving modality information associated with modalities of the control device;
a program code of a second reception step of receiving dialog information associated with dialog of the device to be controlled;
a program code of a generation step of generating bind information that infers a relationship between the modality information and the dialog information, and binds the modality information and the dialog information; and
a program code of a transmission step of transmitting the bind information and the dialog information to the control device.

22. A program for making a computer control an information processing apparatus which serves as a control device that controls an operation of a device to be controlled, comprising:
a program code of a reception step of receiving dialog information associated with dialog of the device to be controlled;
a program code of a generation step of generating bind information that infers a relationship between modality information associated with modalities of the information processing apparatus, and the dialog information, and binds the modality information and the dialog information;
a program code of a management step of managing the modalities in accordance with the modality information; and
a program code of a modality control step of controlling processes between the modality and the dialog in accordance with the bind information.

23. A program for making a computer control an information processing apparatus which serves as a device to be controlled that executes a process on the basis of an instruction from a control device, comprising:
a program code of a transmission step of transmitting dialog information associated with dialog of the information processing apparatus to the control device;
a program code of a dialog execution step of managing the dialog in accordance with the dialog information; and
a program code of a control step of executing control of the information processing apparatus on the basis of an instruction from said dialog execution means.
